(19) United States
(12) Patent Application Publication
(10) Pub. No.: US 2018/0110001 A1
(43) Pub. Date: Apr. 19, 2018

(54) USER TERMINAL AND RADIO COMMUNICATION METHOD

(71) Applicant: NTT DOCOMO, INC., Tokyo (JP)

(72) Inventors: Shimpei Yasukawa, Tokyo (JP); Satoshi Nagata, Tokyo (JP); Yongbo Zeng, Beijing (CN); Qun Zhao, Beijing (CN); Yongsheng Zhang, Beijing (CN)

(73) Assignee: NTT DOCOMO, INC., Tokyo (JP)

(21) Appl. No.: 15/564,780

(22) PCT Filed: Apr. 8, 2016
(86) PCT No.: PCT/JP2016/061611

§ 371 Date: Oct. 6, 2017

(30) Foreign Application Priority Data
Apr. 9, 2015 (JP) 2015-080401
May 14, 2015 (JP) 2015-099438

(51) Int. Cl. H04W 52/02

(52) U.S. Cl. CPC H04W 52/0212; H04W 76/043; H04W 88/04; H04W 76/046; H04W 76/023

(57) ABSTRACT

According to the present invention, in the case where a relaying operation is applied using a user terminal that supports D2D, the power consumption of a user terminal that is used as a relay node can be suppressed. A user terminal is configured to connect with a radio base station and another user terminal, and configured to relay transmission between the radio base station and the other user terminal. The user terminal includes a transmitting section configured to transmit information related to relay capability to the other user terminal; a receiving section configured to receive the information related to relay searching that is transmitted from the other user terminal; and a control section configured to control a connection state with respect to the radio base station. The transmitting section controls a transmission of the information related to relay capability based on the connection state with respect to the radio base station.

### TECHNICAL FIELD

The present invention relates to a user terminal and a radio communication method in a next-generation mobile communication system.

### BACKGROUND ART

In LTE (Long Term Evolution) and successor systems to LTE (e.g., LTE-A (LTE Advanced), FRA (Future Radio Access), also known as 4G, etc.), D2D (Device to Device) technology, in which user terminals directly communicate with each other without communicating via a radio base station, are being studied (e.g., Non-Patent Literature 1).

D2Ds are broadly divided in two types: D2D discovery for finding another user terminal with which communication is possible, and D2D communication (also called D2D direction communication) for directly communicating between terminals. Hereinbelow, when D2D communication and D2D discovery, etc., are not particularly referred to, these will be termed as simply “D2D”. Furthermore, signals that are transmitted and received by the D2D will be termed “D2D signals”.

### CITATION LIST

### Non-Patent Literature

Non-Patent Literature 1: “Key drivers for LTE success: Services Evolution”, September 2011, 3GPP, Internet, URL:

<http://www.3gpp.org/ftp/Information/presentations/presentations_2011/2011_09_LTE_Asia/2011_LTE-Asia_3GPP_Service_evolution.pdf>

### SUMMARY OF INVENTION

### Technical Problem

In regard to D2Ds, the relaying (Layer 3 relaying) using terminals that support D2D is being studied. In such a case, a terminal that supports D2D is used as a relay node, and communication is performed between a radio base station and a remote UE via the relay node. Hence, it becomes possible to support (extend the coverage of) communication between the user terminal (Remote UE), which is present outside the coverage range of the radio base station, and the radio base station.

Whereas, in the case where relaying is performed using a D2D supporting user terminal, it is conceivable for the relay node UE to transmit information related to relaying (relay information) in order for the remote UE to detect and select the relay node UE. On the other hand, if the relay node UE continuously transmits relay information, this enables the remote UE to easily detect and select a relay node UE; however, there is a risk of the relay node UE increasing power consumption.

The present invention has been devised in view of the above discussion, and it is an object of the present invention to provide, in the case where a relaying operation is applied using a user terminal that supports D2D, a user terminal and a radio communication method which can suppress power consumption of a user terminal that is used as a relay node.

### Solution to Problem

According to the present invention, a user terminal is configured to connect with a radio base station and another user terminal, and configured to relay transmission between the radio base station and the other user terminal. The user terminal includes a transmitting section configured to transmit information related to relay capability to the other user terminal; a receiving section configured to receive the information related to relay searching that is transmitted from the other user terminal; and a control section configured to control a connection state with respect to the radio base station. The transmitting section controls a transmission of the information related to relay capability based on the connection state with respect to the radio base station.

### Technical Advantageous of Invention

According to the present invention, in the case where a relaying operation is applied using a user terminal that supports D2D, the power consumption of a user terminal that is used as a relay node can be suppressed.

### BRIEF DESCRIPTION OF DRAWINGS

FIG. 1 is a conceptual diagram of D2D relaying.

FIG. 2 is an illustrative example of operations of relay candidates and remote UEs in D2D relaying.

FIG. 3 is an illustrative example of a connecting method for relay candidates and remote UEs in D2D relaying.

FIG. 4 is an illustrative example of an allocation method for relay capability information and relay search messages.

FIG. 5 is an illustrative example of a transmission method of a relay search message.

FIG. 6 show illustrate examples of a relay operation between a relay node UE, in an RRC idle state, and a remote UE.

FIG. 7 shows an illustrative example of relay operations in an out-of-coverage state.

FIG. 8 shows an illustrative example of an allocation method of relay capability information in accordance with the connection state of the relay node UEs.

FIG. 9 is an illustrative example of a transmission method for relay capability information in accordance with a connection state with a relay node UE.

FIG. 10 is another illustrative example of a transmission method for relay capability information in accordance with a connection state with a relay node UE.

FIG. 11 is another illustrative example of a transmission method for relay capability information in accordance with a connection state with a relay node UE.

FIG. 12 is an illustrative example of an operation method of a relay node UE.

FIG. 13 is an illustrative example of an operation method of a remote UE.

FIG. 14 is another illustrative example of an operation method of a remote UE.

FIG. 15 is an illustrative diagram of a schematic configuration of a radio communication system of according to an illustrated embodiment of the present invention.

FIG. 16 is an illustrative diagram of an overall configuration of a radio base station according to the illustrated embodiment of the present invention.

FIG. 17 is an illustrative diagram of a functional configuration of the radio base station according to the illustrated embodiment of the present invention.

FIG. 18 is an illustrative diagram of an overall configuration of a user terminal according to the illustrated embodiment of the present invention.

FIG. 19 is an illustrative diagram of a functional configuration of the user terminal according to the illustrated embodiment of the present invention.

### DESCRIPTION OF EMBODIMENTS

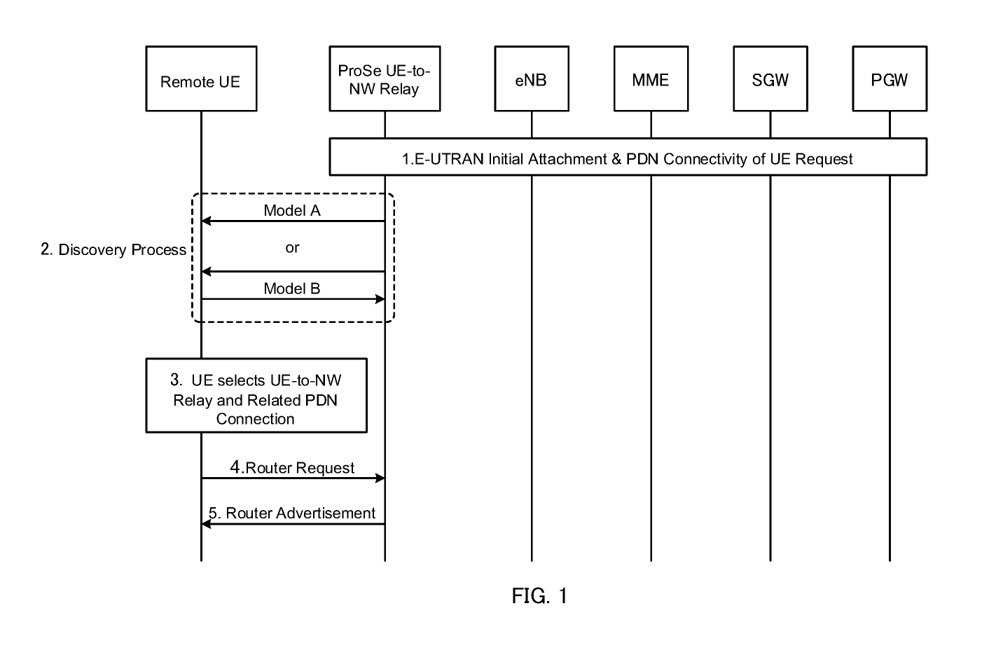

A relay operation (also called “D2D relay”) of FIG. 1 that is used in a D2D supported terminal will hereinafter be discussed.

In a D2D relay, a remote UE communicates over a network via relay node UE (ProSe UE-toNW Relay). In FIG. 1, first an E-UTRAN initial attachment and UE request PDN connectivity are carried out (step 1) between a radio base station (eNB), a relay node UE positioned within the coverage of the radio base station (ProSe UE-to-NW Relay), an MME (Mobility Management Entity), an SGW (Signaling Gateway), and a PGW (Packet Data Network Gateway).

The relay node UE and remote UE perform a discovery process, and discover a terminal with which D2D communication is possible (step 2). Such a discovery process is a model defined in Rel.12, in which model A is disclosed, which discovers a relay node UE by the announcing transmitted from the relay node UE and by monitoring performed in the remote UE. Furthermore, there also is model B, not supported in Rel. 12, which discovers a relay node UE by a request from a remote UE and a response from a relay node UE.

Next, if the remote UE discovers one or more relay node UEs via the discovery process, a terminal selection process is performed to decide which of the relay node UEs to use as a relay device (step 3). At this time, the remote UE may select a related PD connection.

Thereafter, a remote UE IP address process is carried out between the remote UE and the relay node UE. At this stage, a router request is carried out from the remote UE addressed to the relay node UE (step 4), and a router advertisement addressed to the remote UE is sent from the relay node UE in accordance with the router request (step 5). After the above-described processes are performed, a relay process using D2D is implemented.

In a D2D relay as described above, in order for the remote UE to detect and/or select an appropriate relay node, each relay node UE is required to perform a discovery operation which transmits (announces) information related to relaying. Information related to relaying refers to information that is needed in the relaying operation, and includes capability information (relay capability/relay capacity), etc., of the relay node UE. In regard to relay capability, specific examples are: whether a relay operation is possible or not, the total number of links (number of users) that can provide a relay and the number of addable links, and whether or not the relay can be received in an RRC idle state, etc.

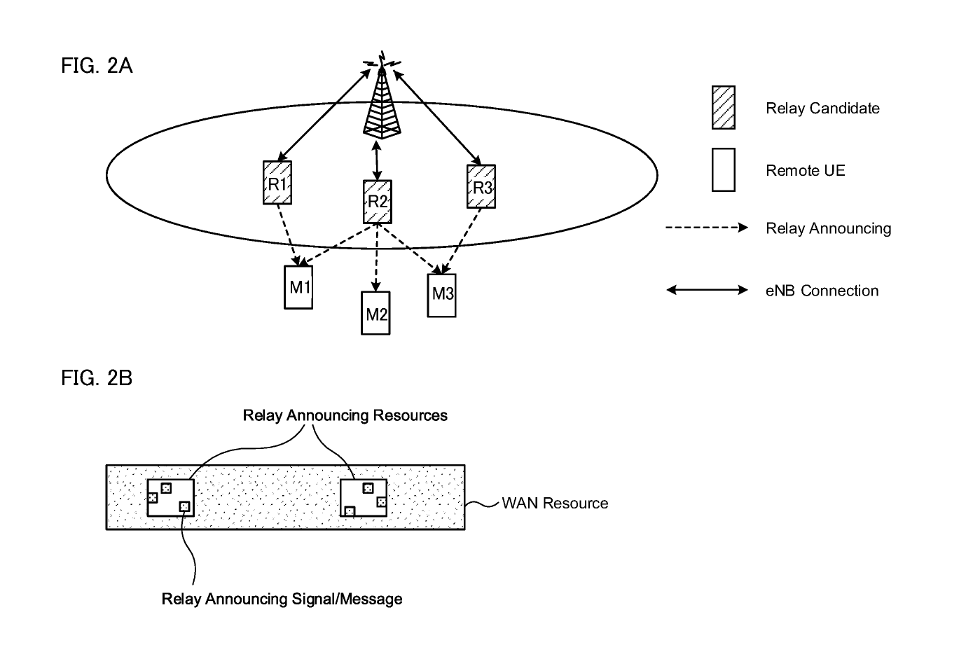

FIG. 2 is an illustrative example of operations of a communication method between a plurality of relay candidates, which are relay node UE candidates, and a plurality of remote UEs. FIG. 2A shows a case in which three relay candidates (R1, R2, R3) are connected to a radio base station, and three remote UEs (M1, M2, M3) which are connected to the radio base station via the relay candidates.

Furthermore, each relay candidate can transmit relay information using an ordinary cellular communication (WAN) radio resource (WAN resource). If the relay candidates respectively transmit relay information, e.g., the relay information (relay announcing signals/messages) of the respective relay candidates can be multiplexed and transmitted to a resource region that is configured for relay announcing use (relay announcing resources) (refer to FIG. 2B).

FIG. 2A shows a case in which a remote UE (M1) receives relay information transmitted from relay candidates (R1, R2), a remote UE (M2) receives relay information transmitted from relay candidate (R2), and a remote UE (M3) receives relay information transmitted from relay candidates (R2, R3). In this case, there is a problem with how to select a relay candidate (relay node UE) in order for a remote UE to apply the relaying operation.

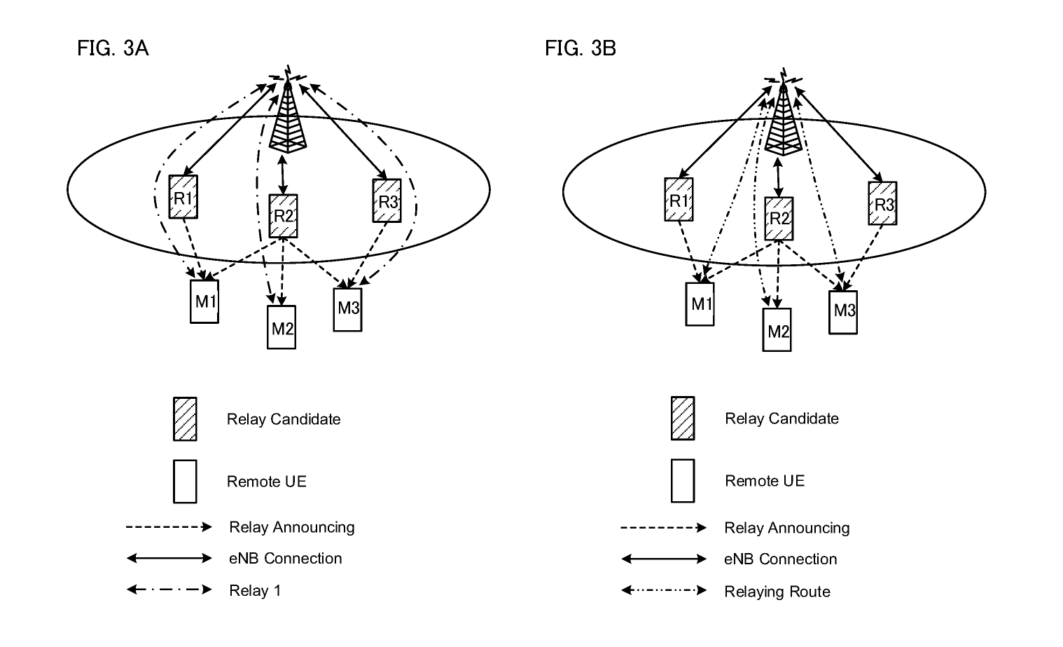

For example, as shown in FIG. 3A, it is conceivable for each remote UE (M1 through M3) to have a different method for selecting a relay candidate (R1 through R3). In such a case, it is conceivable for the remote UEs, which receive relay information transmitted from each relay candidate, to respectively select a relay candidate (a relay candidate that is positioned at the closest distance) to be applied to the relay operation based on the reception power, etc., of the relay information. In the case shown in FIG. 3A, the communication route (relay route) between the radio base station and each remote UE is carried out using different relay candidates, respectively.

Hence, if the relay candidates R1 through R3 operate while being connected to the radio base station (eNB connection) and while also carrying out a relay operation (relay announcing) with respect to the remote UEs, there is a risk of the total power consumption incurred by such a relay operation (in this case, the total power consumption of R1 through R3) becoming high.

Generally, the power consumption of a user terminal that is in an RRC idle state with a radio base station can be made less than a user terminal that is RRC connected with a radio base station. Similarly, the power consumption of a user terminal that is in a DRX-mode connected state (receiving method) with a radio base station can be made less than a user terminal in a normal mode.

For example, one can envisage a case in which a remote UE receives relay information from both a relay candidate that is in an RRC connected state and a relay candidate that is in an RRC idle state. In the case where the remote UE connects with the relay candidate that is in an RRC connected state, the RRC-connected relay candidate can perform a relaying operation between the remote UE and the radio base station while maintaining the RRC connected state.

Whereas, if the remote UE connects the relay candidate that is in an RRC idle state, the RRC idle relay candidate needs to transfer to an RRC connected state in order for the relay operation to be performed. Accordingly, there is a risk of the overall power consumption of the relay node UE increasing. Furthermore, if the remote UE selects the RRC-idle relay candidate, since the relay operation is performed after the relay candidate transfers to an RRC connected state, there is also the risk of a delay occurring in the relay operation compared to the case where an RRC-connected relay candidate is selected.

Consequently, the inventors of the present invention conceived the idea of controlling D2D relaying while considering the connection state (connection circumstances) of the user terminals. Specifically, they conceived the idea of, based on the connection state of the relay node UE (relay candidate), controlling whether or not relay information (e.g., relay capability information) has been transmitted or controlling the transmission method. Furthermore, they also conceived the idea of controlling the connection state of the relay node UE based on information, etc., that is transmitted from the remote UE (e.g., whether or not the remote UE is connected).

By controlling the relay operation based on the connection state of the relay node UE, the remote UEs (M1 through M3) can be controlled to each select a specified relay candidate (R2 in this example), as shown in FIG. 3B. FIG. 3B shows the case where, for example, the relay candidate R2 is in an RRC connected state, relay candidates R1 and R3 are in RRC idle states, and each remote UE (M1 through M3) has selected relay candidate R2 as a relay node UE.

In such a case, the communication route (relay route) between the radio base station and each remote UE can be carried out using the same relay candidate (R2 in this case). By controlling the relaying operation while considering the connection state of the relay candidates in this manner, it is possible to suppress an increase in the total power consumption of the plurality of relay candidates. Furthermore, by selecting the relay candidate that is in an RRC connected state, delay in the relaying operation can be reduced.

Furthermore, relay candidates in an RRC connected state (or in the normal mode) that do not perform the relaying operation can be transferred to an RRC idle state (or the DRX mode) based on predetermined conditions. Accordingly, the power consumption of the relay candidates that do not perform the relaying operation can be reduced. The predetermined conditions can be, for example, the case where the condition for transferring to the RRC idle state (or the DRX mode) as prescribed in an existing system (e.g., LTE Rel. 12, or before) is satisfied, or where no remote UE that requests a relaying operation exists for over a predetermined duration (T_out).

Hereinbelow a detailed description is given of the control or the relaying operation (the operation of the relay node UE and/or the operation of the remote UE) based on the connection state of the relay candidates.

### First Example

A first example will be discussed in regard to a relay node UE operation and a remote UE operation for the case where a relay node UE (relay candidate), the connection state (connection circumstances) thereof being an RRC idle state or in a DRX mode (discontinuous reception), stops the transmission of relay information (relay capability/relay capacity, etc.).

<Remote UE Operation>

If communication is carried out between the remote UE and the radio base station by applying a relay operation (transmitting relay data), the remote UE selects a relay node UE. If a relay node UE cannot be detected (e.g., if relay information cannot be received), the remote UE transmits (announces) information regarding relay searching. Information regarding relay searching (relay searching message) corresponds to a signal that a remote UE that requests relaying transmits in order to search for a relay node UE. Accordingly, it is possible to preferentially select a relay node UE that transmits relay information, and set a connection priority between relay nodes.

The remote UE can multiplex and transmit the information regarding relay searching (hereinafter, “relay searching message”) in a predetermined resource region (resource pool). For example, the remote UE can utilize (reuse) a discovery message to transmit a relay searching message. A discovery message in D2D is a message that is utilized to find another user terminal.

Alternatively, the remote UE can utilize (reuse) an SCI (Sidlink Control Indicator) and/or a data channel, which are control signals that utilize D2D communication for direct transmission between user terminals, to transmit a relay searching message. For example, a PSCCH (Physical Sidelink Control Channel and/or a PSSCH (Physical Sidelink Shared Channel) used for the SCI can be utilized.

The relay searching message can be information including at least one out of: remote UE identification information (Remote UE ProSe ID), identification information of a D2D synchronization signal that is synchronized with the remote UE (D2DSS ID), and information regarding the duration from when the remote UE transmits the relay searching message.

Furthermore, the resource region utilized in the transmission of the relay searching message can be preconfigured in the remote UE. Alternatively, the radio base station can configure the resource region in the remote UE by higher layer signaling, etc. For example, if the remote UE is outside the coverage of the radio base station, the remote UE utilizes the predefined resource region. Furthermore, if the remote UE is present within the coverage of the radio base station, the remote UE can utilize the resource region that is notified by the radio base station.

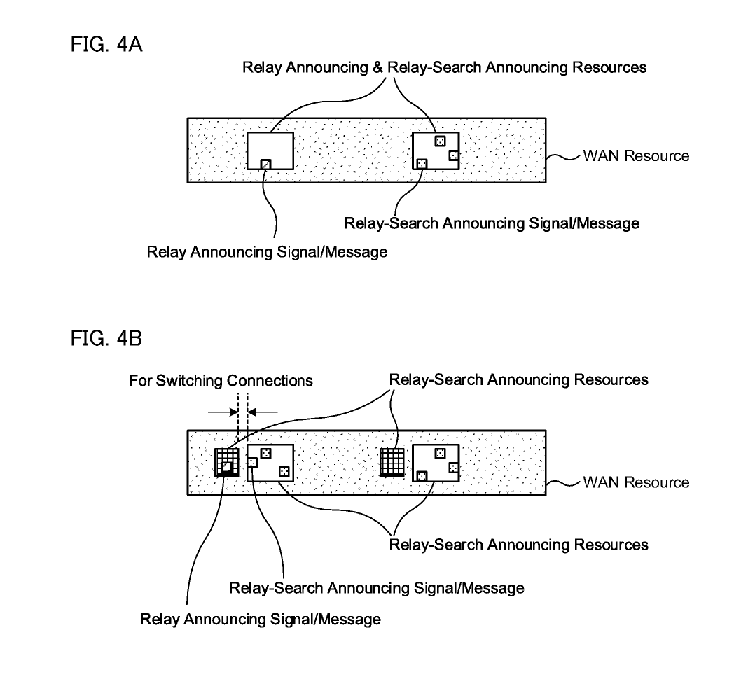

Furthermore, the relay searching message (relay search announcing signal/message) resource region can be set to the same region as that of the resource region (relay announcing resource) for the relay information (relay announcing signal/message) transmitted by the relay node UE (see FIG. 4A). Alternatively, the relay-searching-message resource region can be set to a different region to that of the relay information (hereinafter “relay capability information”) resource region (see FIG. 4B). For example, a relay-discovery resource pool may be time-divided and divided into the transmission regions of the above-mentioned two types of messages, respectively, or different resource pools may be used in the respective message transmissions.

Furthermore, the relay-searching-message resource region may be configured, with respect to a time direction, a predetermined period of time before the relay-capability-information resource region (see FIG. 4B). The predetermined period of time can be determined as a period of time that at least enables the relay node UE to transfer from an RRC idle state to an RRC connected state. Accordingly, the relay node UE that is in an RRC idle state can transfer to an RRC connected state after receiving a relay searching message and can straightaway transmit the relay capability information. Accordingly, it is possible to reduce delay in the relaying operation.

Furthermore, the remote UE may transmit the relay searching message for a predetermined period of time and/or repeat a predetermined number of times. The predetermined period of time and/or the predetermined number of times may use a predefined fixed value, or may use a set value from the radio base station. It becomes possible for the relay node UE to appropriately receive the relay searching message transmitted from the remote UE by the remote UE repeatedly transmitting the relay searching message.

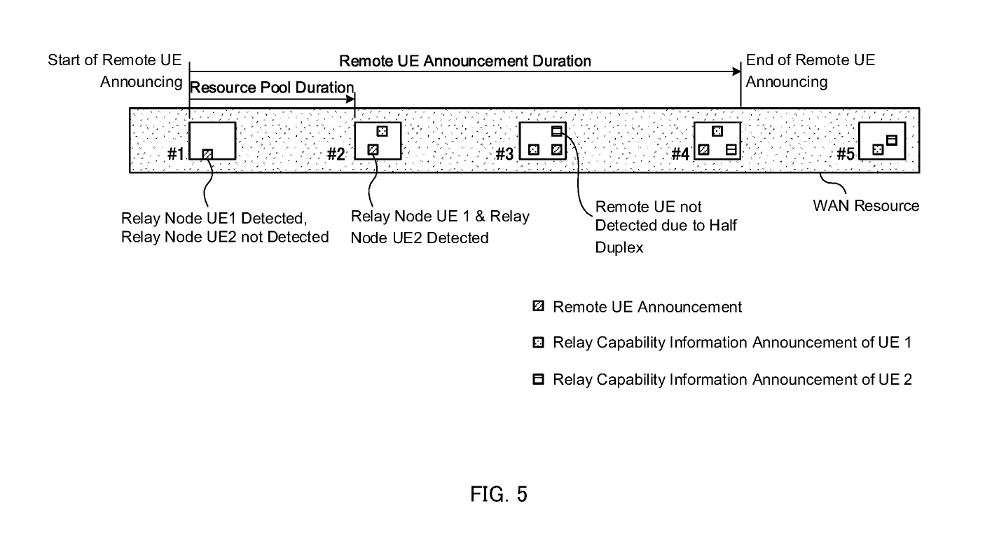

Furthermore, the remote UE may be configured to stop transmission of the relay searching message if the remote UE receives relay capability information transmitted from different relay node UEs a predetermined number of times or more (see FIG. 5). FIG. 5 shows a case where the remote UE stops the transmission of the relay searching message upon the remote UE detecting two relay node UEs.

A first resource region #1 in FIG. 5 indicates a case where a relay UE transmits a relay searching message, a relay node UE1 detects the relay searching message, and a relay node UE2 cannot detect the relay searching message. A second resource region #2 indicates a case where a relay UE transmits a relay searching message and the relay node UE1 transmits relay capability information. Furthermore, this also indicates a case where the relay nodes UE1 and UE2 receive the relay searching message, and the remote UE receives the relay capability information transmitted from the relay node UE1.

A third resource region #3 indicates a case where a relay UE transmits a relay searching message, and the relay nodes UE1 and UE2 transmit relay capability information. Furthermore, this also indicates a case where the remote UE cannot receive the relay capability information transmitted from the relay node UE2. A fourth resource region #4 indicates a case where the relay UE transmits a relay searching message, and the relay nodes UE1 and UE2 transmit relay capability information. Furthermore, this also indicates a case where the remote UE receives relay capability information transmitted from the relay node UE2. In a fourth resource region #3, since the remote UE, after transmitting a relay searching message, receives relay capability information transmitted from two relay node UEs, the relay searching message is stopped at this point in time. In other words, in a fifth resource region #5, the relay UE does not transmit the relay searching message.

Note that the number of times the relay searching message is to be transmitted and/or the transmission period may be expressed using a predefined fixed value, or may use a set value from the radio base station. Furthermore, it is also possible to control the stopping of the transmission of the relay searching message based on the number of times relay capability information has been received after the relay searching message has been transmitted. Hence, in the case where a predetermined number of relay node UEs are detected, an increase in the power consumption of the remote UE can be suppressed by stopping the relay searching messages.

Furthermore, in the case where the relay searching message transmitted from the remote UE and the relay capability information transmitted from the relay node UE share a resource region (see FIG. 5), the transmission configuration of the relay searching message and the transmission configuration of the relay capability information can be configured differently from each other. Note that configurations utilized by each transmission can differ in configuration in regard to at least one of: number of retransmissions, transmission power, transmission period of time, and transmission probability.

<Relay Node UE Operation>

The relay node UEs may be separately configured based on higher layer signaling from the radio base station (eNB), or may be configured at the user terminal based on a RSRP threshold notified by the radio base station. For example, by setting upper and lower limits of a radio quality value of the RSRP, etc., an increase in interference due to user terminals performing relaying at a cell center or at a cell edge can be suppressed, or user terminals performing relaying with an insufficient link quality for relaying can be suppressed.

In the case where a relay node UE transfers to an RRC idle state (or to a DRX mode) based on predetermined conditions, the relay node UE stops the transmission of the relay information that periodically transmits to the remote UEs. Whereas, the relay node UE receives information regarding relay searching (relay searching messages) transmitted from the remote UEs.

The relay node UE detects relay searching messages transmitted from the remote UEs, and counts the number of relay searching messages received (e.g., relay searching messages transmitted from different remote UEs). Furthermore, if the number of relay searching messages satisfies a predetermined condition, the relay node UE can be configured to transfer to an RRC connected state or a normal mode, and transmit relay capability information.

For example, if the relay node UE detects a predetermined number, or more, of different relay searching messages, the relay node UE transfers to an RRC connected state or normal mode. The number of detections of the relay searching messages may be a fixed value, or may be a set value received from the radio base station. Alternatively, the number of detections of the relay searching messages may be a value selected from a non-zero set (e.g., {0, 1, 2, 3}).

Alternatively, the relay node UE may be configured to transfer to an RRC connected state, or a normal mode, in the case where a predetermined period of time has lapsed from when relay searching messages are transmitted, from the remote UE (when relay searching messages are received at the relay node UE). Note that the predetermined period of time may be a fixed value or a value set by the radio base station. Alternatively, the predetermined period of time may be a value selected from a non-zero set (e.g., 0, number list of constant factors of a communication/discovery resource pool period that is transmitted by a relay discovery).

Alternatively, a relay node UE that is in an RRC idle state (or in a DRX mode) may transfer to an RRC connected state after receiving a connection request (e.g., an IP address allocation request, etc.) from a remote UE. In such a case, the remote UE may configure a receiving time window to respond to a connection request in accordance with the RRC state of the relay node UE. For example, a broad time window or a delayed time window may be configured for a response from a relay node UE that is in an RRC idle state. Therefore, relay node connection state information and receiving window information, etc., may be included in the response to the relay searching message from the remote UE. Alternatively, if the remote UE uses Model B Discovery, the remote UE can recognize the RRC idle state (or DRX mode) and may switch the above-described receiving operations.

Furthermore, the relay node UE can perform a control in which the remaining battery level, etc., of the relay node UE is considered when transferring to an RRC connected state or normal mode. Note that a configuration may be provided so that the conditions for the remaining battery level may be set on a relay-node UE-specific basis, or may notified as cell-specific parameters from another user terminal and/or the radio base station.

Furthermore, the relay node UE can include, in the relay capability information that is transmitted thereby, information in regard to the number of relay searching messages (different relay searching messages) received by the relay node UE. Accordingly, the user terminal (e.g., a remove UE) that receives the relay capability information can discern the number of remote UEs that the relay node UE, which is the transmission source of the relay capability information, can apply a relaying operation to.

<Relay Node UE Selection>

The remote UE selects the relay node UE for applying a relaying operation based on predetermined conditions. For example, as shown below, the remote UE can select a specified relay node UE in consideration of the total power consumption of a plurality of relay node UEs (relay node UEs in an RRC connected state and relay node UEs in an RRC idle state).

If it is assumed that the energy per unit time that the user terminal in an RRC connected state consumes is “a”, and the energy per unit time that the user terminal in an RRC idle state consumes is “b” (a>b), if a plurality of relay candidates and a remote UE are present, the total energy consumption of the relay node UEs can be presumed as “a”×(relay node UEs in RRC connected state)+“b”×(relay node UEs in RRC idle state). Accordingly, one conceivable method to minimize the total energy (total power) would be to minimize the number of relay node UEs which cover the remote UEs.

Such a method is known as a “minimum set cover problem”, and specifically, a greedy algorithm, etc., can be utilized.

For example, in the case where information in regard to the number of relay searching messages received by the relay node UE is transmitted by being included in the relay capability information, the remote UE can select a relay node UE by prioritizing the relay node UE that has the most number of relay searching messages out of those in the received relay capability information.

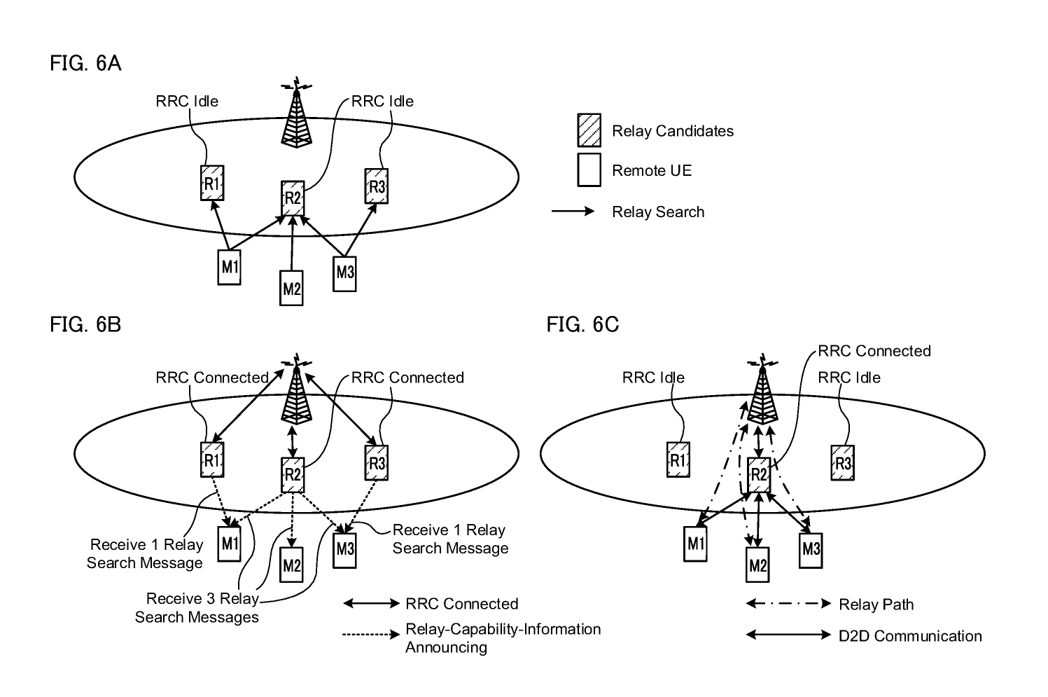

FIG. 6 shows an example of a method used by the remote UE to select a relay node UE. FIG. 6A shows a case in which each remote UE (M1 through M3) transmits a relay searching message, and the relay node UEs (R1 through R3) receive the relay searching messages. Furthermore, FIG. 6 indicates a case in which the relay node UEs (R1 through R3) are in an RRC idle state (do not transmit relay capability information). In the explanations hereinbelow, it is assumed that R1 receives a relay searching message transmitted from M1, R2 receives relay searching messages transmitted from M1 through M3, and R3 receives a relay searching message transmitted from M3.

The relay node UEs (R1 through R3), which have received relay searching messages, each transfer from an RRC idle state to an RRC connected state based on predetermined conditions, and each transmits relay capability information (see FIG. 6B). Information in regard to the number of relay searching messages that the relay node UEs have received is included in the respective relay capability information. In this example, information that the number of relay searching messages is “1” is included in the relay capability information transmitted from R1 and R3, and information that the number of relay searching messages is “3” is included in the relay capability information transmitted from R2.

Each remote UE (M1 through M3) selects a relay node UE to apply the relay operation based on the received relay capability information. In this example, each remote UE selects the relay node UE (R2) that has received the largest number of relay searching messages (see FIG. 6C). Accordingly, the remote UEs (M1 through M3) carry out communication with the radio base station via the relay node UE (R2). Whereas, the relay node UEs (R1 and R3) that were not selected by the remote UEs enter into an RRC idle state (or a DRX mode) if they do not receive a relay request (e.g., a relay searching message) from another remote UE within a predetermined period of time.

<Out of Coverage Relay>

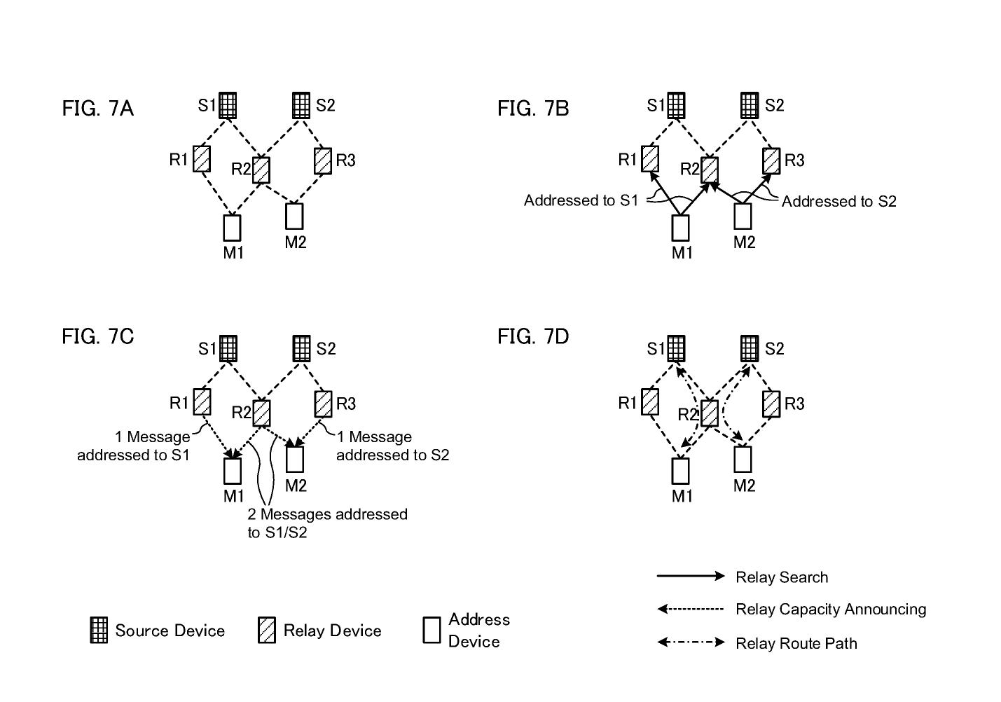

In the present embodiment, D2D relaying can also be applied to the case where all of the user terminals are in an RRC idle state (OOC: Out of Coverage). FIG. 7 shows an example of a relaying operation in out-of-coverage relay. In this example, it is assumed that the relay devices (R1 through R3) perform a relaying operation with source devices (S1 and S2) and destination devices (M1 and M2). Note that in an out-of-coverage relay, the source devices, the relay devices and the destination devices do not necessarily need to maintain connection with the radio base station.

The relay devices can stop the transmission of the relay capability information in the case where there are no destination devices (remote UEs) that are attached to the relay devices (relay UEs) over a predetermined period of time (see FIG. 7A).

Whereas, in the case where a relay device cannot be discovered (e.g., when relay capability information cannot be received) when the relaying operation is being applied, the destination devices (M1 and M2) transmit relay searching messages (see FIG. 7B). Note that in this case it is assumed that the destination device M1 requests communication with the source device S1, and the destination device M2 requests communication with the source device S2.

The relay devices that receive relay searching messages respectively transmit relay capability information that includes information regarding the number of relay searching messages received (see FIG. 7C). In this case, the relay capability information transmitted from R1 includes information that the number of relay searching messages for S1 is “1”. Furthermore, the relay capability information transmitted from R2 includes information that the number of relay searching messages for S1 and S2 is “1”, respectively (“2” in total). Furthermore, the relay capability information transmitted from R3 includes information that the number of relay searching messages for S2 is “1”.

Each destination device (M1 and M2) selects a relay device to apply a relaying operation based on the received relay capability information. In this case, each destination device preferentially selects the relay device (R2) that has received the largest number of relay searching messages (see FIG. 7D). In this case, the destination device UE (M1 and M2) respectively performs communication with the source devices S1 and S2 via the relay device (R2).

Hence, even in an out-of-coverage relay, a relaying operation can be controlled while considering the connection circumstances, etc., with the relay device. Accordingly, an increase in the total power consumption of the relay devices can be suppressed.

Note that in the present embodiment, a plurality of conditions may be combined as a method for the remote UE to select a relay node UE. For example, the remote UE may select a predetermined relay node UE with consideration of the number of times relay searching information, included in the capability information received from the relay node UE, has been received, and with consideration of the UL transmission power of the relay node UE. For example, in the case where the relay node UE transmission power is designated as “p” and the number of relay searching messages is designated as “N”, the remote UE can preferentially select a relay node UE based on the value of N/p.

Alternatively, the remote UE may select a predetermined relay node UE with consideration of the number of times relay searching information, included in the capability information received from the relay node UE, has been received, and with consideration of the throughput of the relay node UE. For example, in the case where the throughput of the relay node UE is designated as “Th” and the number of relay searching messages is designated as “N”, the remote UE can preferentially select a relay node UE based on the value of “a”×“N”+“b”×“Th”. Note that “a” and “b” are predetermined parameters.

### Second Example

A second example will be discussed in regard to a relay node UE operation and a remote UE operation for the case where a relay node UE (relay candidate), the connection state thereof being an RRC idle state or in a DRX mode, performs the transmission of relay information (relay capability/relay capacity, etc.).

<Relay Node UE Operation>

In the case where the relay node UE enters into an RRC idle state (or a DRX mode) based on predetermined conditions, the relay node UE continues to carry out the transmission of the relay information to the remote UE; however, this the transmission of the relay information can be applied to the transmission configuration (or the transmission method) of the relay capability information in an RRC connected state, or can be changed to the transmission configuration (or the transmission method) of the relay capability information in an RRC idle state and applied thereto.

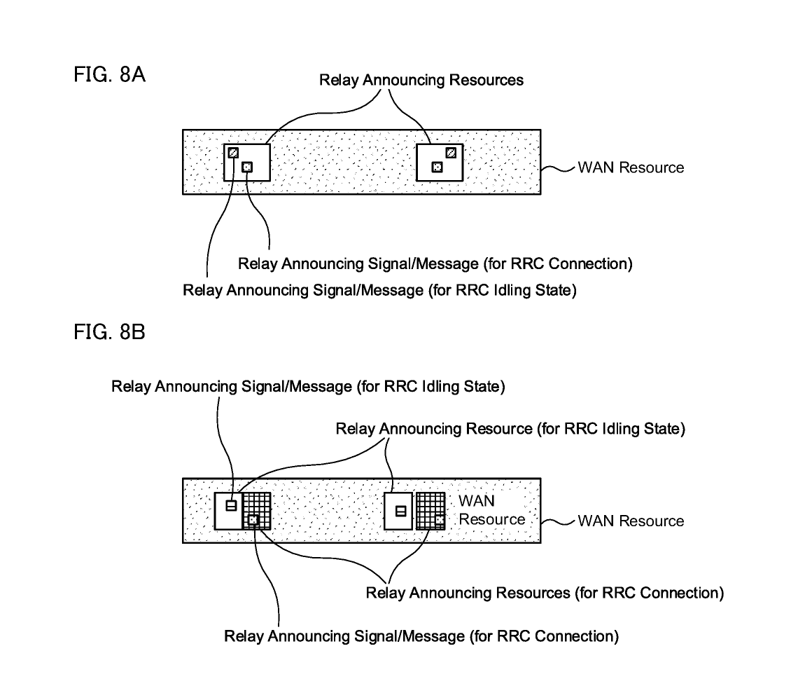

Each relay node UE controls the transmission of the relay capability information in order to identify the connection state (RRC connected state/RRC idle state) of the relay node UE. For example, bit information (e.g., 1 bit) that identifies the connection state of the relay node UE can be included in the relay capability information. In such a case, relay capability information that is transmitted by a relay node UE in an RRC connected state and relay capability information that is transmitted by a relay node UE in an RRC idle state can be allocated in the same resource region (e.g., a resource region that the user terminal can autonomously allocate (Type 1 discovery or Mode 2 communication resource pool)) (see FIG. 8A).

The remote UE can discern the connection state of the relay node UE based on the bit information that is included in the received relay capability information.

Furthermore, each relay node UE can change the relay-capability-information transmission configuration (or transmission method) in accordance with the connection state of the relay node UE in order to identify the connection state of the relay node UEs. For example, the relay node UE can allocate relay capability information that is transmitted in an RRC connected state in a different resource region from relay capability information that is transmitted in an RRC idle state (see FIG. 8B).

As an example, a relay node UE in an RRC idle state utilizes a resource region that the user terminal can autonomously allocate (Type 1 discovery or Mode 2 communication resource pool). Whereas, a relay node UE in an RRC connected state utilizes a resource region configured by the radio base station (Type 2B discovery resource pool). Of course, the resource regions are not limited thereto.

<Remote UE Operation>

The remote UE discerns the connection state of each relay node UE based on relay capability information transmitted from each relay node UE, and selects a specified relay node UE. For example, the remote UE can preferentially select a relay node UE that is in an RRC connected state. Accordingly, it is possible to reduce a delay in the relaying operation, and to reduce the total power consumption for the relaying operation.

<Selection of Relay Node UE in RRC Idle State>

It is assumed that the remote UE selects a relay node UE that is in an RRC idle state based on received relay capability information, etc. (e.g., in the case where there is no relay node UE that is in an RRC connected state). In such a case, the relay node UE that is selected by the remote UE can enter into an active state/RRC connected state based on a predetermined message. An example of the predetermined message can be the RS message (router request) transmitted from the remote UE in step 4 of the SA2 procedures shown in FIG. 1.

Alternatively, another example of the predetermined message can be D2D data and/or a discovery message transmitted from the remote UE. Note that this message is transmitted from the remote UE that requests connection with the network (NW) via the relay node UE.

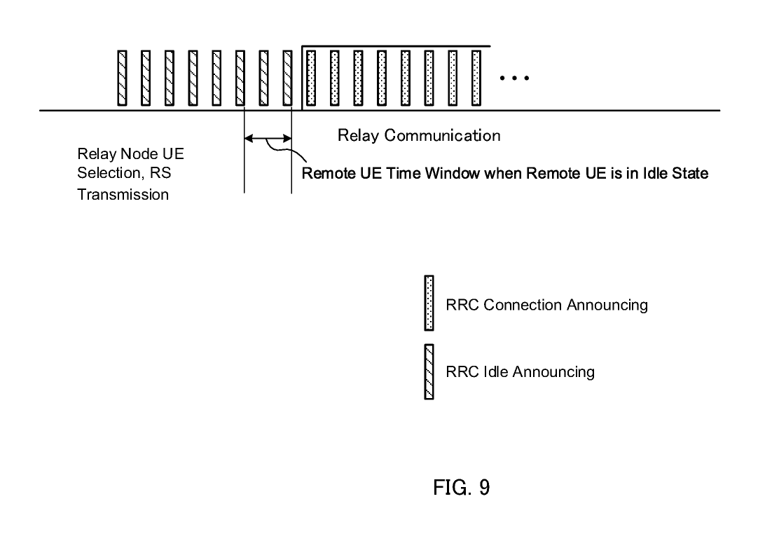

Furthermore, in the case where the remote UE selects a relay node UE that is in an RRC idle state, the remote UE needs to wait until an RRC connection state of the relay node UE is established (see FIG. 9). The period of time that the remote UE waits (waiting time window) can be determined as a fixed value or a value set by the relay node UE. In other words, the waiting time for the case where the remote UE selects an RRC connected relay node UE and the waiting time for the case where the remote UE selects an RRC idle relay node UE are different.

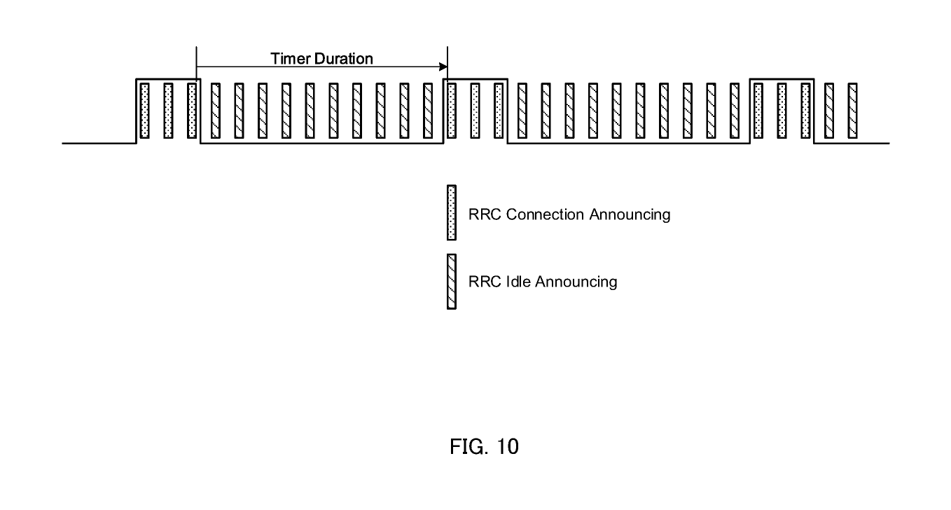

An expiration timer for the waiting time of the remote UE can be included in the relay capability information, etc., transmitted from the relay node UE that is in an idle state. For example, providing the timer does not expire, the relay node UE that is in an idle state can carry out transmission (announcing) of relay capability information that includes the timer. FIG. 10 shows a case where the RRC idle state duration corresponds to a timer duration. For example, the relay node UE can transmit relay capability information that is announced during the timer duration and includes information regarding the timer.

Furthermore, the timer may be configured to be set by the radio base station, and in such a case, the extension or expiration of the timer can be controlled by higher layer signaling (e.g., RRC signaling) from the radio base station. Furthermore, when the timer expires, a user terminal in an RRC idle state enters into an RRC connection mode, so that transmission (announcing) of user capability information can continue.

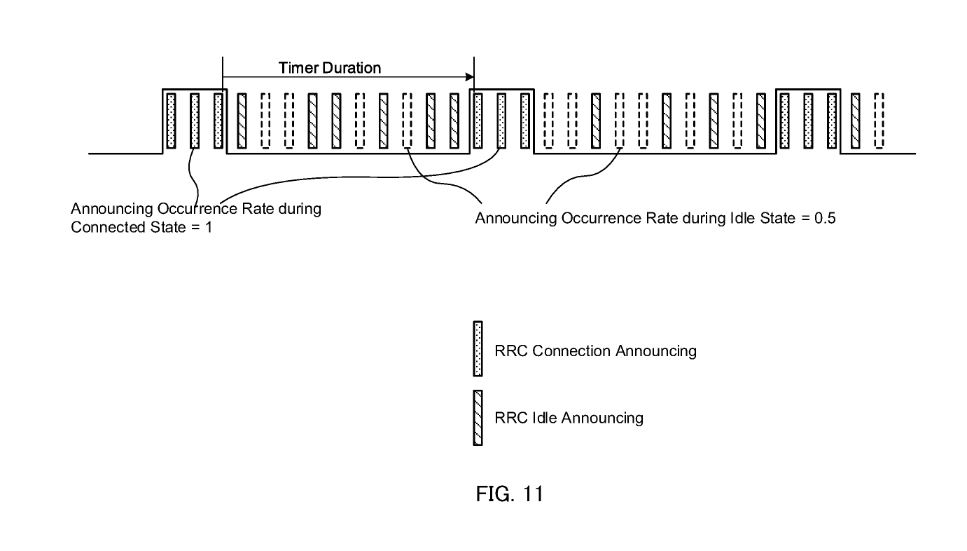

If the relay node UE is in an RRC idle state, a transmission configuration (announcing configuration) of the relay capability information can be applied, unlike in the case of an RRC connected state. The transmission configuration of the relay capability information includes a transmission period (announcing period), a transmission probability (announcing probability), transmission power (announcing Ts power), and number of retransmissions, etc. For example, the relay capability information that is transmitted in an RRC connected state and the relay capability information that is transmitted in an RRC idle state share the same resource; whereas, a different transmission probability and/or transmission power can be applied. FIG. 11 shows a case where the transmission probability of the relay capability information that is transmitted in an RRC connected state is 1, and the transmission probability of the relay capability information that is transmitted in an RRC idle state is 0.5.

Note that the transmission configuration of each transmission state may be set in advance, or can be set based on a downlink signal (e.g., RRC signaling, or broadcast signal, etc.) transmitted from the radio base station. The transmission period, transmission probability and/or the transmission power of the relay capability information that is transmitted in an RRC idle state can be set as a ratio with respect to an RRC connected state.

(Relay Node UE Operation)

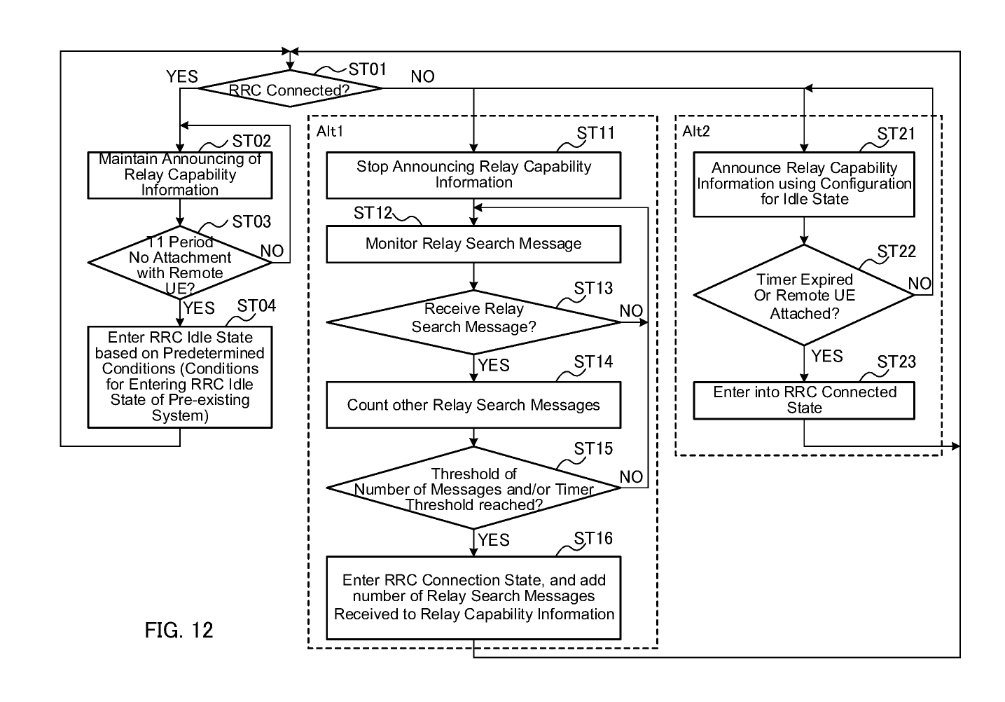

FIG. 12 shows an example of a relay node UE operation. First of all, the relay node UE determines the connection state (RRC connected state or RRC idle state) of the relay node UE (ST01). If the relay node is in an RRC connected state (ST01—YES), the relay node UE maintains transmission of the relay capability information (ST02). The relay node UE determines whether or not it is attached with a remote UE during a predetermined period (T1) (ST03); if there is a remote UE attached (ST03—NO), the transmission of the relay capability information is maintained. If there is no remote UE attached (ST03—YES), the relay node UE enters an RRC idle state if the conditions for transferring to an RRC idle state in an existing system are satisfied (ST04).

If the relay node UE is in an RRC idle state (ST01—NO), the relay node UE applies the above-described first example (Alt1) or the above-described second example (Alt2). In Alt1, the relay node UE that is in an RRC idle state stops the transmission of the relay capability information (ST11), and monitors the relay searching messages transmitted from the remote UE (ST12). If relay searching messages are received (ST13—YES), the relay searching messages are counted. If the number of received relay searching messages or the receiving duration satisfies a predetermined value (ST15—YES), the relay node UE enters into an RRC connected state, and the relay capability information is transmitted with the number of received relay searching messages included therein (ST16).

In Alt2, the relay node UE that is in an RRC idle state controls the transmission of the relay capability information in order to identify a connected state (ST21). In the case where a predetermined attachment request from a remote UE upon a timer expiring or the relay node UE being selected by the remote UE (ST22—YES), the relay node UE enters into an RRC connected state (ST23).

(Remote UE Operation)

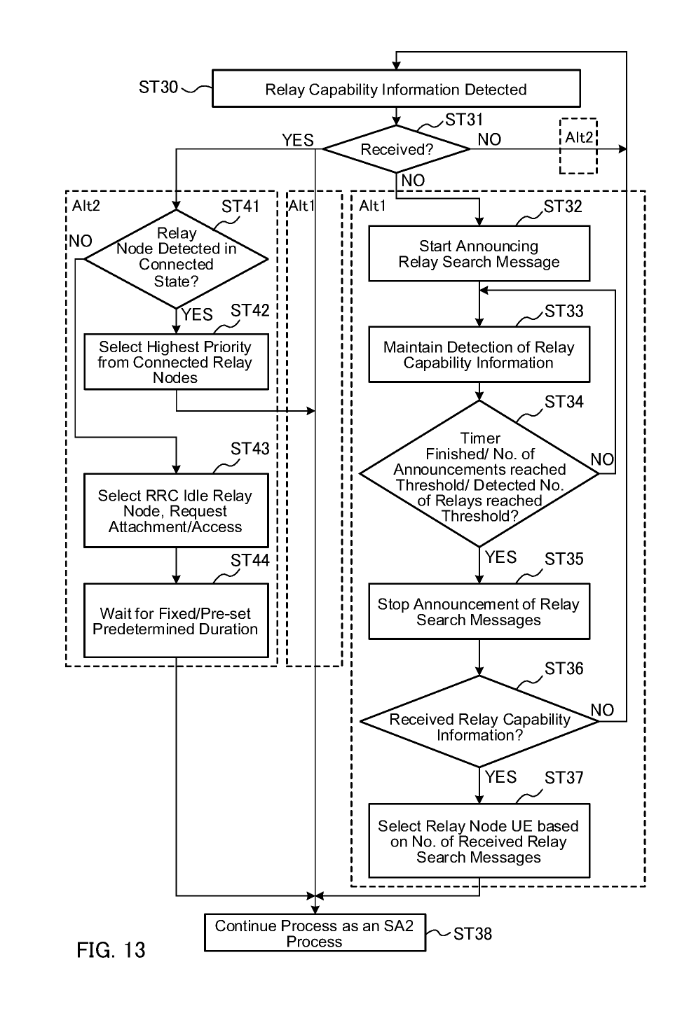

FIG. 13 shows an example of a remote UE operation. The remote UE detects relay capability information (ST30). If the remote UE cannot receive the relay capability information (ST31—NO), in the second example (Alt2), the relay capability information continues to be detected.

Whereas, in the first example (AM), if the remote UE cannot receive relay capability information (ST31—NO), the remote UE transmits relay searching messages (ST32) and maintains detection of relay capability information (ST33). If predetermined conditions (expiration of the relay searching message timer, number of received relay capability information, and/or number of detected relay node UEs) are satisfied (ST34—YES), the relay searching messages are stopped (ST35), and it is determined whether or not a relay capability information has been received (ST36). If relay capability information is received (ST36—YES), the relay node UE having received the most number of relay searching messages in the relay capability information is preferentially selected (ST37), and a relaying operation is performed (ST38).

If the remote UE receives relay capability information (ST31—YES), a relaying operation is performed in the first example (Alt1) (ST38). Whereas, in the second example (Alt2), if the remote UE receives relay capability information (ST31—YES), the remote UE determines that a relay node UE in an RRC connected state has been detected (ST41). If a relay node UE is detected (ST41—YES), the relay node UE that is in an RRC connected state is preferentially selected (ST42), and a relaying operation is performed (ST38). Note that if there are a plurality of relay node UEs that are in an RRC connected state, the same method as that of the first example can be applied.

If the remote UE cannot detect a relay node UE that is in an RRC connected state (ST41—NO), the remote UE selects a relay node UE that is in an idle state and requests attachment/access (ST43). Thereafter, after a predetermined period (time window) of waiting (ST44), the remote UE performs a relaying operation with the relay node UE that has entered into an RRC connected state (ST38).

### Modified Embodiment

Note that in the present embodiment, the first example (Alt1) and the second example (Alt2) can be applied by being combined (coexist) with each other. The operation of the first example or the operation of the second example may be configured in the user terminal, or an appropriate combination of the operation of the first example and the operation of the second example may be applied. For example, whether or not the relay node UE that has entered into an RRC idle state (or DRX mode) transmits relay capability information may be set in advance, or may be set by the radio base station. If set by the radio base station, a user-specific or cell-specific downlink signal can be used to notify the relay node UE.

Furthermore, in the case where a combination of the first example and the second example is applied, and where a relay node UE to which the first example is applied is present and a relay node UE to which the second example is applied is present, the remote UE can be configured to select the relay node UE to which the second example is applied. However, in the case where a relay node UE that is in an RRC connected state can be preferentially selected, the first example may be applied.

(Remote UE Operation)

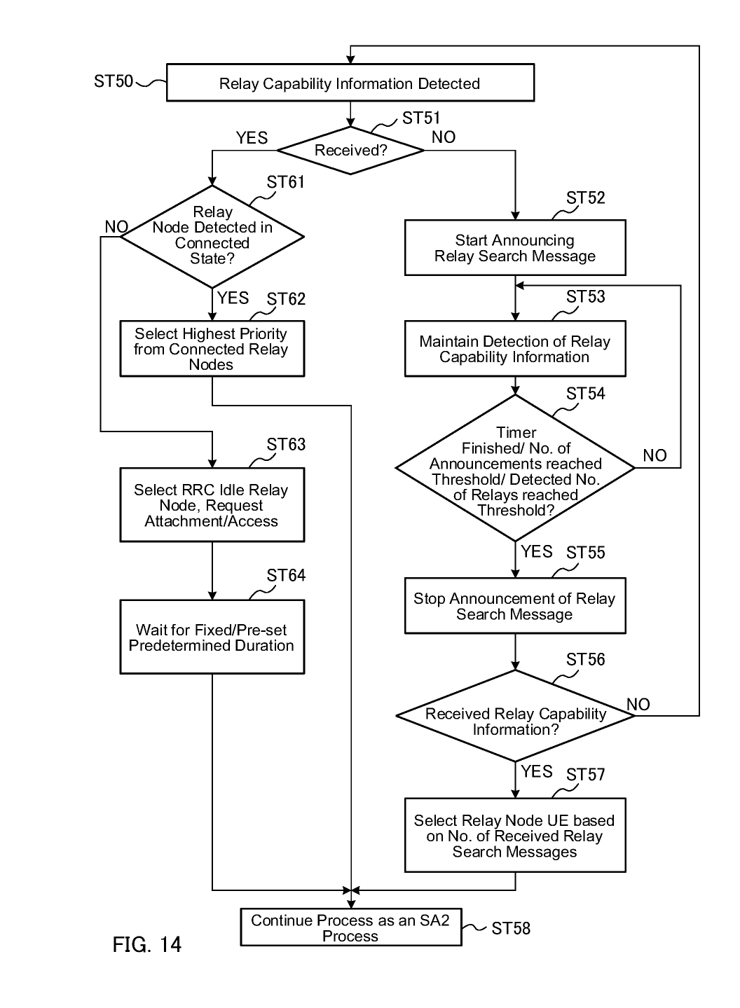

FIG. 14 shows an example of a remote UE operation. The remote UE detects relay capability information (ST50). If the remote UE cannot receive the relay capability information (ST51—NO), the remote UE transmits relay searching messages (ST52) and maintains detection of relay capability information (ST53). If predetermined conditions (expiration of the relay searching message timer, number of received relay capability information, and/or number of detected relay node UEs) are satisfied (ST54—YES), the relay searching messages are stopped (ST55), it is determined whether or not a relay capability information has been received (ST56). If relay capability information is received (ST56—YES), the relay node UE having received the most number of relay searching messages in the relay capability information is preferentially selected (ST57), and a relaying operation is performed (ST58).

If the remote UE receives relay capability information (ST51—YES), the remote UE determines that a relay node UE in an RRC connected state has been detected (ST61). If a relay node UE is detected (ST61—YES), the relay node UE that is in an RRC connected state is preferentially selected (ST62), and a relaying operation is performed (ST58). Note that is there are a plurality of relay node UEs that are in an RRC connected state, the same method as that of the first example can be applied.

If the remote UE cannot detect a relay node UE that is in an RRC connected state (ST61—NO), the remote UE selects a relay node UE that is in an idle state and requests attachment/access (ST63). Thereafter, after a predetermined period (time window) of waiting (ST64), the remote UE performs a relaying operation with the relay node UE that has entered into an RRC connected state (ST58).

### Third Example

A third example will be discussed in regard to the relay information transmitted from the relay node UE (also called “relay capability information” or “relay discovery information”) being controlled in accordance with whether or not the relay node UE can transfer to an RRC connected state (RRC_connected).

It is assumed that the relay node UE that is in an RRC idle state (RRC_idle) supports the relay information transmission (e.g., the above-described second example). In such a case, it is assumed that the remote UE requests a relay operation based on relay information transmitted from a relay node UE that is in an RRC idle state.

However, if the relay node UE that is in an RRC idle state cannot transfer to an RRC connected state, a relay operation that uses such a relay node UE cannot be performed. Furthermore, in this case, such relay information that is transmitted from a relay node UE that cannot transfer to an RRC connected state and processes in the remote UE that receive such relay information becomes wasted, possibly increasing delay in establishing relay connection.

Furthermore, a case is assumed in which the relay node UE that is in an RRC idle state (RRC_idle) does not transmit relay information and responds based on information from the remote UE (e.g., the above-described second example or model B). In such a case, it is assumed that the remote UE performs a relaying operation based on information that the relay node UE responds with to the request from the remote UE.

However, if the relay node UE which receives the request from the remote UE cannot transfer to an RRC connected state, a relaying operation utilizing such a relay node UE cannot be performed. Furthermore, in such a case, response signals transmitted from a relay node UE that cannot transfer to an RRC connected state, and processes in the remote UE that receives such response signals become wasted, possibly increasing delay in establishing a relay connection.

Therefore, in the third example, the transmission of the relay information is controlled in accordance to whether or not the relay node UE (relay candidate) can transfer to an RRC connected state (whether predetermined conditions are satisfied or not). Note that the relay information is not limited to relay information transmitted from a relay node UE in model A, and may include response signals to signals (request signals in model B, or relay searching messages in the second example) transmitted from the remote UE.

<The Case where Relay Information Transmission is Supported when in RRC Idle State>

First of all, the case in which relay information transmission is supported by a relay node UE that is in an RRC idle state will be discussed hereinbelow.

In this case, transmission conditions for relay information can be set for a relay node UE that is in an RRC idle state. A state in which an RRC connection can be established (or a state in which an RRC connection cannot be established) can be set as a transmission condition for relay information. A relay node UE that is in an RRC idle state can control the transmission of signals relating to a relaying operation based on the set transmission conditions.

Transmission conditions for signals related to a relaying operation may be defined in specifications, etc., in advance, or may be configured in the relay node UE from the radio base station. In the case where the radio base station configures the transmission conditions of the relay information in the relay node UE, broadcast information (SIB: System Information Block) or higher layer signaling, etc., may be used.

For example, a user terminal that determines, based in the predetermined conditions, that an RRC connected state cannot be established in a cell in which a relay operation is possible, can perform a control so that signals relating to a relaying operation are not transmitted. Examples of signals relating to a relaying operation are: (1) relay information transmitted from a relay node UE, (2) another AS (Access Stratum) message, (3) router advertisement (RA) when an IPv6 address is used and/or a DHCPv4 offer when an IPv4 address is used. The relay node UE may be controlled to not to carry out signal transmission of any of the above (1) through (3), or can be controlled to not carry out transmission of predetermined signals.

Examples of conditions (e.g., conditions for determining that a user terminal cannot establish an RRC connected state) for not carrying out transmission of signals relating to relaying information are: (A) when access to a cell is limited, (B) when an RRC connection is rejected (when a RRCConnectionReject is received), and (C) when a problem in the random access sequence is detected (e.g., when radio link failure occurs).

For example, the user terminal can perform a control in which transmission of relay information, etc., is not carried out upon receiving a RRCConnectionReject, and determining that an RRC connected state cannot be established within a predetermined period of time (while a timer 302 or timer 325, which are designated by an existing system, is operating) designated by the radio base station.

Furthermore, (D) consideration of reception power (RSRP) and/or reception quality (RSRQ) may be a transmission condition for the relay information. For example, if the reception power (RSRP) and/or the reception quality (RSRQ) do not satisfy predetermined conditions, the relay node UE can be controlled to not carry out transmission of relay information, etc.

Hence, due to the relay node UE controlling the relaying operation (transmission of relay information) in accordance with whether it is possible for the relay node UE to enter into an RRC connected state (RRC_connnected), wasted operations in the relay node UE and/or the remote UE can be reduced. Accordingly, an increase in power consumption can be suppressed.

<The Case where Relay Information Transmission is not Supported when in RRC Idle State>

In the case where relay information transmission is not supported by a relay node UE that is in an RRC idle state, the relay node UE receives signals (request signals, and relay searching messages) from the remote UE and transmits a response signal.

In the present embodiment, the relay node UE can control whether or not to receive signals transmitted from the remote UE based on predetermined conditions. Furthermore, even if signals transmitted from the relay node UE are received, a control can be performed which determines, before the relay node UE transmits a response signal, etc. (relay information, etc.), whether or not the relay node UE can transfer to an RRC connected state, and transmits the response signal, etc., in accordance with whether nor not transferal is possible.

Specifically, reception conditions can be configured for signals (e.g., request signals, etc., in model B) transmitted from the remote UE with respect to a relay node UE that is in an RRC idle state. A predetermined reception power (RSRP) and/or a reception quality (RSRQ) can be configured as reception conditions for request signals. For example, if reception power and/or reception quality of the request signals transmitted from the remote UE is greater or equal to a predetermine value, the relay node UE can operate to receive the request signals.

The reception conditions for the signals transmitted from the remote UE may be defined by specifications, etc., in advance, or may be configured in the relay node UE from the radio base station, or the reception conditions may be configured in the user terminal in accordance with instructions from the higher layer. In the case where the radio base station configures the transmission conditions of the relay information in the relay node UE, broadcast information (SIB: System Information Block) or higher layer signaling, etc., may be used.

Furthermore, in the case where the relay node UE that receives request signals, etc., transmitted from the remote UE is in an RRC idle state, the relay node UE can perform a control, before transmitting signals related to the relaying operation, to transfer to an RRC connected state. Examples of signals relating to a relaying operation are: (1) relay information transmitted from a relay node UE, (2) another AS (Access Stratum) message, (3) router advertisement (RA) when an IPv6 address is used and/or a DHCPv4 offer when an IPv4 address is used.

If it is determined that the relay node UE cannot transfer to an RRC connected state (e.g., when it cannot transfer to an RRC connected state within a predetermined period of time, or when transmission of signals related to relay information from a base station are not permitted), the relay node UE performs a control to not carry out transmission of signals related to relay information. Alternatively, the relay node UE may be configured to notify the remote UE and/or the radio base station that the relay node UE failed to enter into an RRC connected state. Furthermore, the relay node UE may be configured to not receive request signals from remote UEs if the relay node UE determines that it cannot enter into an RRC connected state.

Hence, by controlling the relay operation in accordance with whether or not the relay node UE can enter into an RRC connected state, the occurrence of unwanted operations can be reduced, and an increase in the delay in regard to the relay connection can be suppressed. For example, in the third example which is included in an embodiment of the present invention, the following configuration can be achieved.

A user terminal is configured to connect with a radio base station and another user terminal, and configured to relay transmission between the radio base station and the other user terminal. The user terminal includes a transmitting section configured to transmit information related to relay capability to the other user terminal; a receiving section configured to receive the information related to relay searching that is transmitted from the other user terminal; and a control section configured to control a connection state with respect to the radio base station. The transmitting section controls a transmission of the information related to relay capability based on the connection state with respect to the radio base station.

### Modified Embodiment

In the above-described example, the relay node UE can autonomously decide to transmit relay information based on transmission conditions for relay information notified in an SIB. Whereas, a case is also assumed in which the relay node UE cannot be notified, utilizing an SIB, of transmission conditions, etc. In such a case, a relay node UE that has established an RRC connection (RRC connected) can be configured to perform a transmission request of relay capability information to a serving cell (radio base station) using higher layer signaling.

The radio base station that receives a transmission request from the relay node UE can either permit or reject the request from the relay node UE based on predetermined conditions (e.g., uplink and downlink throughput, radio quality, and congestion of the cell).

### Fourth Example

The third example teaches the case where it is specified, as an UE operation, in the relay information (e.g., relay discovery) transmission whether or not an RRC connection with a relay node UE is necessary; however, the present example is not limited thereto. For example, a configuration is possible in which a resource pool that can be utilized in the transmission of relay information using broadcast information (e.g., SIB, etc.), etc., can be configured in the user terminal without specifying, as an UE operation, in the relay information transmission whether or not an RRC connection with a relay node UE is necessary.

By configuring in the user terminal a resource pool that can be utilized in the transmission of relay information using broadcast information, etc., relay information can also be transmitted to a user terminal that is in an RRC idle state. Such a configuration can be favorably used, e.g., in a cell having a small number of terminals within a coverage of a suburban macro cell or an independent small cell, etc.

Furthermore, it is possible for relay information to be transmitted only to user terminals that are in an RRC connected state using a resource pool that can be utilized in the relay information using broadcast information without using a configuration in the user terminals (e.g., by configuring via RRC signaling, etc.). Such a configuration can be favorably used for, e.g., cells in which a large number of terminals are present within a coverage of an urban macro cell, etc.

In the case where the radio base station configures a resource pool that can be utilized in the transmission of relay information using broadcast information (e.g., an SIB, etc.), the radio base station can notify a user terminal (e.g., a relay node UE) of a resource pool configuration for a relay-information (Relay discovery) transmission (method 1) separately from the normal transmission resource pool configuration. Alternatively, the radio base station can notify, out of resource pools that can be used in relay-information (Relay discovery) transmission, a resource pool or a region within a resource pool that can be used in relay-information (Relay discovery) transmission (method 2) using a bitmap or a resource pool index, etc.

Furthermore, the radio base station may transmit a relay information transmission request by higher layer signaling from the relay node UE to a user terminal (relay node UE) that is in an RRC connected state, and control the transmission operation of the relay information in an relay node UE based on a request from the user terminal. For example, the radio base station can configure, in a relay node UE, a relay-information transmission resource pool in which the relay node UE can autonomously select a resource, or a predetermined resource, based on a transmission request from the relay node UE.

In this case, the relay node UE can transmit the relay information using the resource (resource pool for transmission of relay information) autonomously selected by the user terminal or the predetermined resource configured by the radio base station. Accordingly, a configuration is possible in which some of the user terminals that have a sufficient backhaul quality can be selected to transmit relay information thereto.

Furthermore, in regard to relay information for notifying that data that does not require an RRC connection for reception, as with (e)MBMS, can be relayed, independent configuration information may be notified via broadcast information in order to independently configure transmission conditions for the relay information. For example, it is conceivable to have a configuration in which (RRC_idle) it is possible to transmit relay information for (e)MBMS even in an RRC idle state, and in which relay information is permitted to be transmitted for other data only in an RRC connected state (RRC_connected). Parameters may be included in this broadcast information in order to standardize the transmission configuration between relay terminals in order to receive (e)MBMS in an SFN. Such parameters can be, for example: scrambling, DM-RS series, resource allocation (mapping, etc., between the received (e)MBMS resources and the relay transmission resources), modulation coding schemes (MCS), and higher layer header information, etc.

(Configuration of Radio Communication System)

The following description concerns the configuration of a radio communication system according to an embodiment of the present invention. In this radio communication system, the D2D resource determining method pertaining to the above-described examples are adopted. Furthermore, the above-described first example and second example can be used by being appropriately combined.

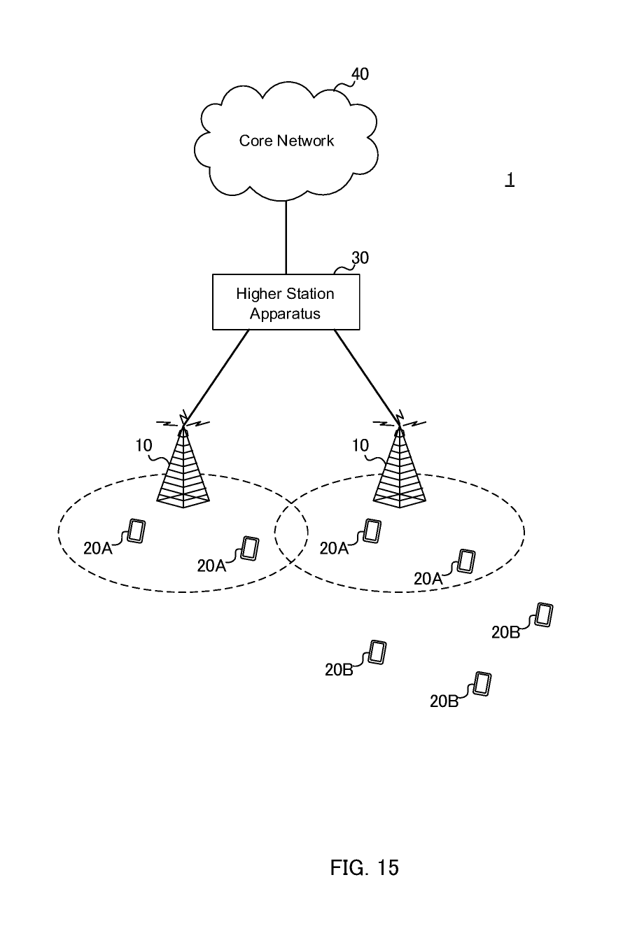

FIG. 15 is a schematic structure diagram showing an example of the radio communication system according to the present embodiment. As shown in FIG. 15, a radio communication system 1 includes a plurality of radio base stations 10, a plurality of user terminals 20A that are present within cells formed by each radio base station 10 and are configured to be capable of communicating with each radio base station 10, and user terminals 20B which can connect to the radio base stations 10 using the user terminals 20A as relay node UEs. The radio base stations 10 are each connected with a host station apparatus 30, and are connected to a core network 40 via the host station apparatus 30.

The user terminals 20A correspond to relay node UEs, and the user terminals 20B correspond to remote UEs. Note that the user terminals 20A and 20B can respectively configured to include both the function of performing a relaying operation as a relay node, and the function of a remote UE. In the following descriptions, the user terminals (simply referred as “user terminals 20”) have both functions of a relay node UE and a remote UE. The present embodiments are of course not limited thereto.

The radio base station 10 is a radio base station having a predetermined coverage. Note that the radio base station 10 may be a macro base station having a relatively wide coverage, or may be a small base station having a local coverage.

Note that the macro base station may be called an eNB (eNodeB), aggregation node, or a transmission point, etc. The small base station may be called a micro base station, a pico base station, a femto base station, HeNB (Home eNodeB), RRH (Remote Radio Head), or a transmission point, etc.

The same frequency band may be used or respectively different frequency bands may be used in the cells formed by the radio base stations 10. Furthermore, the radio base stations 10 may be connected with each other via an inter-base station interface (for example, optical fiber, the X2 interface, etc.).

The user terminals 20 are terminals to support various communication schemes such as LTE, LTE-A, FRA, etc., and may include both mobile communication terminals and stationary communication terminals. The user terminals 20 can communicate with other user terminals 20 via the radio base stations 10. Furthermore, the user terminals 20 can communicate with other user terminals 20 via by D2D communication, without communicating with the radio base stations 10.

Note that the host station apparatus 30 may be, for example, an access gateway apparatus, a radio network controller (RNC), a mobility management entity (MME), etc., but is not limited thereto.

In the radio communication system 1, OFDMA (Orthogonal Frequency Division Multiple Access) is applied to the downlink and SC-FDMA (Single-Carrier Frequency Division Multiple Access) is applied to the uplink as radio access schemes. Note that the uplink and downlink radio access schemes are not limited to these combinations.

In the radio communication system 1, a sidelink shared channel (PSSCH: Physical Sidelink Shared Channel), which is shared by each user terminal 20, a broadcast channel (PSBCH: Physical Sidelink Broadcast Channel), a sidelink control channel (PSCCH: Physical Sidelink Control Channel) for transmitting scheduling allocation (SA), etc., and a sidelink discovery channel (PSDCH: Physical Sidelink Discovery Channel) which is utilized for user terminal discovery, etc., are used as channels.

Furthermore, in the radio communication system 1, the user terminals 20 can use the uplink to transmit D2D signals. Note that the present invention is not limited thereto; D2D signals may be transmitted by utilizing a different radio access scheme and/or a different radio resource to that of the uplink.

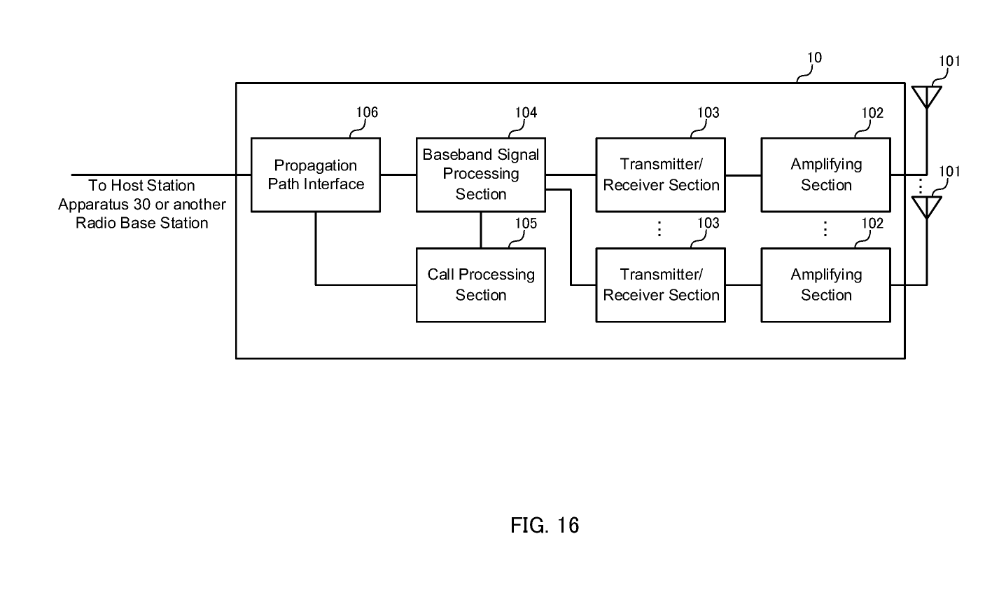

FIG. 16 is a diagram showing an overall structure of a radio base station 10 according to the present embodiment. The radio base station 10 is configured to have a plurality of transmission/reception antennas 101 for MIMO transmission, amplifying sections 102, transmitting/receiving sections 103, a baseband signal processing section 104, a call processing section 105 and a propagation path interface 106. Furthermore, each transmitting/receiving section 103 is configured of a transmitting section and a receiving section.

User data that is to be transmitted on the downlink from the radio base station 10 to the user terminal 20 is input from the host station apparatus 30, via the propagation path interface 106, into the baseband signal processing section 104.

In the baseband signal processing section 104, in regard to the user data, signals are subjected to PDCP (Packet Data Convergence Protocol) layer processing, RLC (Radio Link Control) layer transmission processing such as division and coupling of user data and RLC retransmission control transmission processing, MAC (Medium Access Control) retransmission control (e.g., HARQ (Hybrid Automatic Repeat reQuest) transmission processing), scheduling, transport format selection, channel coding, inverse fast Fourier transform (IFFT) processing, and precoding processing, and resultant signals are transferred to the transmission/reception sections 103. Furthermore, in regard to downlink control signals, transmission processing is performed, including channel coding and inverse fast Fourier transform, and resultant signals are also transferred to the transmission/reception sections 103.

Each transmitting/receiving section 103 converts the downlink signals, output from the baseband signal processing section 104 after being precoded per each antenna, to a radio frequency band and transmits this radio frequency band. The radio frequency signals that are subject to frequency conversion by the transmitting/receiving sections 103 are amplified by the amplifying sections 102, and are transmitted from the transmission/reception antennas 101. In addition, the transmitting/receiving sections 103 transmit, to each user terminal 20, information regarding the D2D resource region and information regarding the initial allocation position of the D2D resource. Based on common recognition in the field of the art pertaining to the present invention, each transmitting/receiving section 103 can correspond to a transmitter/receiver, a transmitter/receiver circuit or a transmitter/receiver device.

Whereas, in regard to the uplink signals, radio frequency signals received by each transmission/reception antenna 101 are amplified by each amplifying section 102. The transmitting/receiving sections 103 receive the uplink signals that are amplified by the amplifying sections 102, respectively. The transmitting/receiving sections 103 frequency-convert the received signals into baseband signals and the converted signals are then output to the baseband signal processing section 104.

The baseband signal processing section 104 performs FFT (Fast Fourier Transform) processing, IDFT (Inverse Discrete Fourier Transform) processing, error correction decoding, MAC retransmission control reception processing, and RLC layer and PDCP layer reception processing on user data included in the input uplink signals. The signals are then transferred to the host station apparatus 30 via the propagation path interface 106. The call processing section 105 performs call processing such as setting up and releasing a communication channel, manages the state of the radio base station 10, and manages the radio resources.

The propagation path interface 106 performs transmission and reception of signals with the host station apparatus 30 via a predetermined interface. Furthermore, the propagation path interface 106 can perform transmission and reception of signals (backhaul signaling) with a neighboring radio base station via an inter-base-station interface (for example, optical fiber, X2 interface). For example, the propagation path interface 106 may transmit and receive, between the radio base station 10 and a neighboring radio base station, information regarding the D2D resource region and information regarding the initial allocation position of the D2D resource with respect to each user terminal 20.

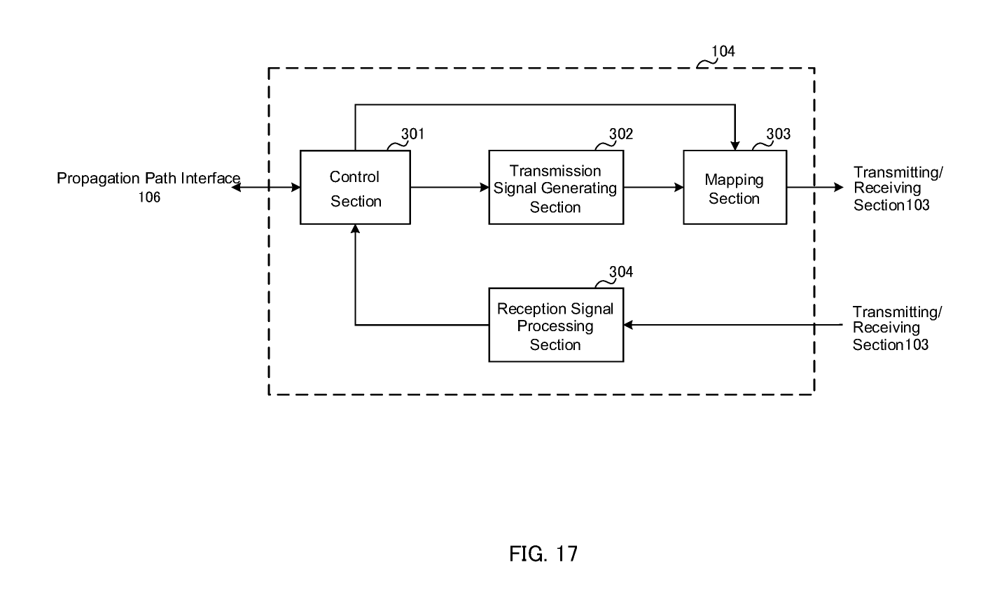

FIG. 17 is a diagram illustrating the functional configurations of the baseband signal processing section 104, provided in the radio base station 10, according to the present embodiment. Note that although FIG. mainly shows functional blocks of the features of the present embodiment, the radio base station 10 is also provided with other functional blocks that are necessary for carrying out radio communication.

As illustrated in FIG. 17, the baseband signal processing section 104 provided in the radio base station 10 includes at least a control section (scheduler) 301, a transmission signal generating section 302, a mapping section 303, and a reception signal processing section 304.

The control section 301 controls the scheduling (allocation control) of radio resources to downlink signals and uplink signals based on feedback information from each user terminal 20 and instruction information from the host station apparatus 30. In other words, the control section 301 serves as a scheduler. Note that in the case where another radio base station 10 or the host station apparatus 30 functions as a scheduler for the radio base station 10, the control section 301 does not need to function as a scheduler. Based on common recognition in the field of the art pertaining to the present invention, the control section 301 can be applied to a controller, a control circuit or a control device.

The control section 301 controls the transmission signal generating section 302 and the mapping section 303.

Specifically, the control section 301 controls the scheduling of downlink reference signals, downlink data signals transmitted in a PDSCH, and downlink control signals transmitted in a PDCCH and/or EPDCCH. Furthermore, the control section 301 controls the scheduling of uplink reference signals, uplink data signals transmitted in a PUSCH, uplink control signals transmitted in a PUCCH and/or a PUSCH, and an RA preamble transmitted in a PRACH.

For example, the control section 301 can control the radio resource allocation based on instruction information from the host station apparatus 30 or feedback information (e.g., channel state information (CSI)) reported from a user terminal 20. Information regarding allocation control is notified to the user terminal 20 using downlink control information (DCI).

Furthermore, the control section 301 configures a time/frequency resource region (resource pool) which can allocate D2D signals in a user terminal 20 that can transmit and receives D2D signals. For example, the D2D resource can be configured at a predetermined period. Furthermore, control of the transmission signal generating section 302 and the mapping section 303 is performed in order to generate, and transmit to the user terminal 20, information relating to the D2D resource region and information related to the initial allocation position for the D2D resource.

The transmission signal generating section 302 generates downlink control signals, downlink data signals and downlink reference signals that have been allocated by the control section 301 and are output to the mapping section 303. Specifically, the transmission signal generating section 302 generates a DL assignment to notify the user terminal of allocation of downlink signals, and a UL grant to notify the user terminal of allocation of uplink signals based on instructions from the control section 301. Furthermore, a coding rate determined based on CSIs, etc., from the user terminals 20, a coding process in accordance with a modulation scheme, and a modulation process are carried out in the downlink data signals. Based on common recognition in the field of the art pertaining to the present invention, the downlink control signal generating section 302 can be applied to a signal generator or a signal generating circuit.

Based on instructions from the control section 301, the mapping section 303 maps the downlink signal generated in the transmission signal generating section 302 to radio resources to output to the transmitting/receiving sections 103. Based on common recognition in the field of the art pertaining to the present invention, the mapping section 303 can correspond to a mapping circuit and a mapper.

The reception signal processing section 304 performs a receiving process (e.g., demapping, demodulation, and decoding, etc.) on uplink signals (e.g., a delivery acknowledgement signal (HARQ-ACK), data signals transmitted on the PUSCH) transmitted from the user terminal. Based on common recognition in the field of the art pertaining to the present invention, the mapping section 304 can be applied to a mapping circuit and a mapper.

Furthermore, the reception signal processing section 304 may measure the reception power (RSRP) and the channel state. Furthermore, the reception signal processing section 304 may decide whether or not a transmission control is needed for each subframe based on the coding result of the received signals. The information extracted from the received signals by the reception signal processing section 304 and the obtained measurement information are output to the control section 301.

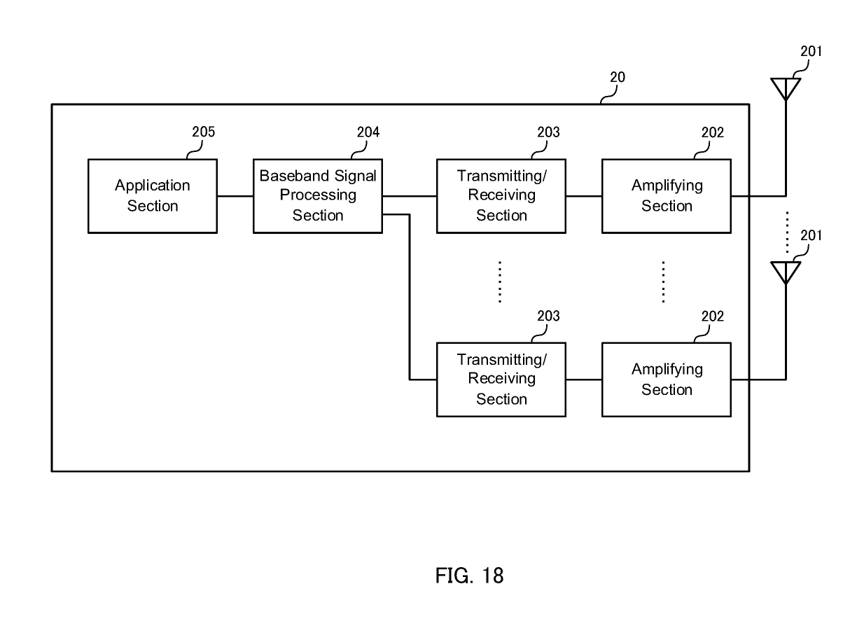

FIG. 18 is a diagram illustrating the entire configuration of the user terminal 20 according to the embodiment of the present invention. Note that FIG. 18 mainly shows functional blocks of the features of the present embodiment; the user terminal 20 is also provided with other functional blocks that are necessary for carrying out radio communication. Furthermore, the user terminal 20 can have a configuration which includes both the function of a relay node that performs a relaying operation, and the function of a remote UE. In the following descriptions, the user terminal 20 includes both functions of a relay node UE and a remote UE, however, the present invention is not limited thereto.

As shown in FIG. 18, the user terminal 20 is provided with a plurality of transmitting/receiving antennas 201 for MIMO communication, amplifying sections 202, transmitting/receiving sections 203, a baseband signal processing section 204 and an application section 205. Note that each transmitting/receiving section 203 may be configured of a transmitting section and a receiving section.

Radio frequency signals that are received in the plurality of transmitting/receiving antennas 201 are respectively amplified in the amplifying sections 202. Each transmitting/receiving section 203 receives a downlink signal that has been amplified by an associated amplifying section 202. The transmitting/receiving sections 203 perform frequency conversion on the reception signals to convert into baseband signals, and are thereafter output to the baseband signal processing section 204.

If the user terminal functions as a relay node UE, each of the transmitting/receiving sections 203 functions as a transmitting section which transmits information related to relay capability to other user terminals (remote UEs), and functions as a receiving section which receives information related to relay searching (relay searching messages) transmitted from relay node UEs. Furthermore, each transmitting/receiving section 203 can control the transmission of the information related to relay capability based on the connection state with the radio base station.

Furthermore, if the connection state of the relay node UE is an RRC idle state or a DRX mode, each transmitting/receiving section 203 stops the transmission of information related to relay capability, and can receive information related to relay searching. Furthermore, each transmitting/receiving section 203 can transmit information on the number of times relay searching messages have been received. Furthermore, each transmitting/receiving section 203 can transmit information related to relay capability in order to identify the relay node UE connection state. For example, each transmitting/receiving section 203 can transmit information related to relay capability in a predetermined resource region based on the connection state.

Furthermore, each transmitting/receiving section 203 determines whether or not an RRC connection is possible with the radio base station based on predetermined information, and can control transmission of the information related to relay capability (third example).

In the case where the user terminal functions as a remote UE, each transmitting/receiving section 203 functions as a transmitting section which transmits information related to relay searching to other user terminals (relay node UEs), and functions as a receiving section which receives information related to relay capability that is transmitted from the relay node UE. Furthermore, each transmitting/receiving section 203 can control the transmission of relay searching messages based on the receiving conditions of the information related to the relay capability information.

Based on common recognition in the field of the art pertaining to the present invention, the transmitting/receiving section 203 can correspond to a transmitter/receiver, a transmitting/receiving circuit or a transmitting/receiving device.

The input baseband signal is subjected to an FFT process, error correction decoding, a retransmission control receiving process, etc., in the baseband signal processing section 204. The downlink user data is forwarded to the application section 205. The application section 205 performs processes related to higher layers above the physical layer and the MAC layer. Furthermore, out of the downlink data, broadcast information is also forwarded to the application section 205.

On the other hand, uplink user data is input to the baseband signal processing section 204 from the application section 205. In the baseband signal processing section 204, a retransmission control transmission process (e.g., a HARQ transmission process), channel coding, precoding, a discrete fourier transform (DFT) process, an inverse fast fourier transform (IFFT) process, etc., are performed, and the result is forwarded to each transmitting/receiving section 203. The baseband signal that is output from the baseband signal processing section 204 is converted into a radio frequency band in the transmitting/receiving sections 203. Thereafter, the amplifying sections 202 amplify the radio frequency signal having been subjected to frequency conversion, and transmit the resulting signal from the transmitting/receiving antennas 201.

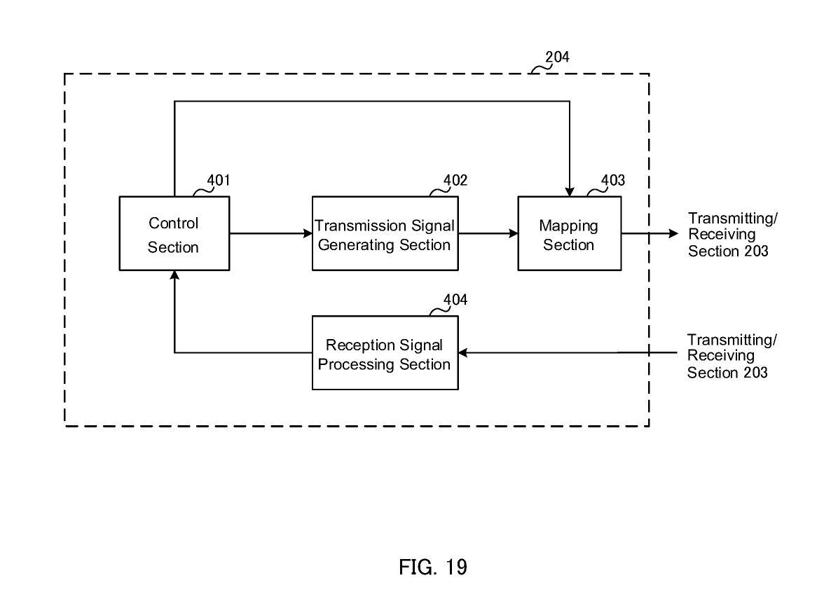

FIG. 19 is a diagram showing the main functional structure of the baseband signal processing section 204 provided in the user terminal 20. As shown in FIG. 19, the baseband signal processing section 204 provided in the user terminal 20 includes at least a control section 401, a transmission signal generating section 402, a mapping section 403, and a reception signal processing section 404.

The control section 401 obtains the downlink control signals (signals transmitted on a PDCCH/EPDCCH) and the downlink data signals (signals transmitted on a PDSCH), which were transmitted from the radio base station 10, from the reception signal processing section 404. The control section 401 controls generation of the uplink control signals (e.g., delivery acknowledgement signals (HARQ-ACK), etc.) and the uplink data signals based on the determination result of whether or not a retransmission control is necessary for the downlink control signals and the downlink data signals. Specifically, the control section 401 controls the transmission signal generating section 402 and the mapping section 403. Based on common recognition in the field of the art pertaining to the present invention, the control section 401 can correspond to a controller, a control circuit or a control device.

The control section 401 can configure the D2D resource based on information related to a D2D resource region (e.g., information related to resource allocation) included in the received signal that is transmitted from the radio base station 10.

Furthermore, in the case where the user terminal 20 functions as a relay node UE, the control section 401 can control the connection state with the radio base station (RRC connection state/RRC idle state, or DRX mode/normal mode). For example, in an existing system, if transfer conditions for entering into an RRC idle state or the transfer conditions for entering into a DRX mode are satisfied, and there are no other user terminals (remote UEs) connected, the control section 401 can control the transferring to an RRC idle state or a DRX mode. Furthermore, the control section 401 can control the transferring to an RRC connected state or a normal mode based on the receiving conditions of the relay searching messages.

Furthermore, in the case where the user terminal 20 functions as a relay node UE, the control section 401 can control the selection of a predetermined user terminal by a relaying operation, based on the number of times relay searching messages have been received or the connection state of the relay node UE that is identified in the information related to relay capability.

The transmission signal generating section 402 generates uplink control signals, e.g., delivery acknowledgement signals (HARQ-ACK) and channel state information (CSI), etc., based on commands from the control section 401. Furthermore, the transmission signal generating section 402 generates uplink data signals based on commands from the control section 401. Based on common recognition in the field of the art pertaining to the present invention, the transmission signal generating section 402 can be a signal generator or a signal generation circuit.

Note that in the case where a UL grant is included in the downlink control signal notified by the radio base station, the control section 401 commands the transmission signal generating section 402 to generate uplink data signals. Furthermore, the control section 401 commands the transmission signal generating section 402 to generate D2D data if a D2D data grant is included in the control signal notified by the radio base station.

The mapping section 403 maps the uplink signal generated by the transmission signal generating section 402, based on instructions from the control section 401, and outputs the generated signal to the transmitting/receiving sections 203. For example, the mapping section 403 allocates a D2D signal in a D2D resource based on a command from the control section 401. Based on common recognition in the field of the art pertaining to the present invention, the mapping section 403 can correspond to a mapper, a mapping circuit or a mapping device.

The reception signal processing section 404 performs reception processing (e.g., demapping, demodulation, decoding, etc.) on the received signals (e.g., a downlink control signal transmitted from the radio base station, a downlink data signal transmitted in a PDSCH, and D2D signal transmitted from another user terminal). Based on common recognition in the field of the art pertaining to the present invention, the reception signal processing section 404 can correspond to a signal processor, or a signal processing circuit.

Furthermore, the reception signal processing section 404 may measure the received power (RSRP) and the channel state, etc. Furthermore, the reception signal processing section 404 may determine whether or not a retransmission control of each subframe is needed based on the coding results of the received signals.

The information extracted from the received signals by the reception signal processing section 404 and the obtained measurement information are output to the control section 401. For example, the reception signal processing section 404 outputs, to the control section 401, scheduling information (uplink resource allocation information, etc.) included in the downlink control signal, information related to a cell that provides feedback to a delivery acknowledgement signal on the downlink control signal, and the channel state, etc. Furthermore, the reception signal processing section 404 outputs, to the control section 401, information related to a D2D resource region included in the received signal, and information related to initial resource allocation of the D2D signal.

Furthermore, the block diagrams used in the above description of the present embodiment indicate function-based blocks. These functional blocks (configured sections) are implemented via a combination of hardware and software. Furthermore, the implementation of each functional block is not limited to a particular means. In other words, each functional block may be implemented by a single device that is physically connected, or implemented by two or more separate devices connected by a fixed line or wirelessly connected.

For example, some or all of the functions of the radio base station 10 and the user terminal 20 may be implemented by using hardware such as ASICs (Application Specific Integrated Circuits), PLDs (Programmable Logic Devices) and FPGAs (Field Programmable Gate Arrays), etc. Furthermore, the radio base station 10 and the user terminal 20 may be each implemented by a computer device that includes a processor (CPU), a communication interface for connecting to a network, a memory and a computer-readable storage medium that stores a program(s).

The processor and memory, etc., are connected to buses for communication of information. Furthermore, the computer-readable storage medium includes, e.g., a flexible disk, a magnetic-optical disk, ROM, EPROM, CD-ROM, RAM, or a hard disk, etc. Furthermore, the program(s) may be transmitted from a network via electric telecommunication lines. Furthermore, the radio base station 10 and the user terminal 20 may also include an input device such as input keys, and an output device such as a display.

The functional configurations of the radio base station 10 and the user terminal 20 may be implemented using the above-mentioned hardware, may be implemented using software modules that are run by a processor, or may be implemented using a combination of both thereof. The processor controls the entire user terminal by operating an operating system. Furthermore, the processor reads a programs, software modules and data from the storage medium into a memory, and performs the various processes thereof accordingly. The above-mentioned program only needs to be a program that can perform the operations described in the above embodiment on a computer. For example, the control section 401 of the user terminal 20 may be stored in the memory, and implemented by the processor operating a control program, and the other above-mentioned functional blocks can also be implemented in the same manner.

Hereinabove, the present invention has been described in detail by use of the foregoing embodiments. However, it is apparent to those skilled in the art that the present invention should not be limited to the embodiment described in the specification. For example, the above-described embodiments can be used separately or as a combination thereof. The present invention can be implemented as an altered or modified embodiment without departing from the spirit and scope of the present invention, which are determined by the description of the scope of claims. Therefore, the description of the specification is intended for illustrative explanation only and does not impose any limited interpretation on the present invention.

The disclosures of Japanese Patent Application No. 2015-080401, filed on Apr. 9, 2015, and Japanese Patent Application No. 2015-099438, filed on May 14, 2015, are incorporated herein by reference in their entireties.

1. A user terminal configured to connect with a radio base station and another user terminal, and configured to relay transmission between the radio base station and the other user terminal, said user terminal comprising:
a transmitting section configured to transmit information related to relay capability to the other user terminal;
a receiving section configured to receive the information related to relay searching that is transmitted from the other user terminal; and
a control section configured to control a connection state with respect to the radio base station,
wherein the transmitting section controls a transmission of the information related to relay capability based on the connection state with respect to the radio base station.

2. The user terminal according to claim 1, wherein in the case where the connection state is an RRC idle state or a DRX mode, the transmitting section stops transmitting the information related to relay capability, and the receiving section receives the information related to relay searching.

3. The user terminal according to claim 1, wherein in the case where, in an existing system, transfer conditions for entering into an RRC idle state or transfer conditions for entering into a DRX mode are satisfied, and there are no other user terminals connected, the control section controls a transferring to the RRC idle state or the DRX mode.

4. The user terminal according to claim 1, wherein the control section controls a transferring to an RRC connected state or a normal mode based on reception conditions of the information related to relay searching.

5. The user terminal according to claim 4, wherein the transmitting section transmits the information regarding the number of times the information related to relay searching has been received.

6. The user terminal according to claim 1, wherein the transmitting section transmits the information related to relay capability by a different configuration for each connection state.

7. The user terminal according to claim 6, wherein the transmitting section transmits the information related to relay capability using a different resource region and/or different bit information in accordance with the connection state.

8. A user terminal configured to connect with a radio base station by relaying via another user terminal, said user terminal comprising:
a transmitting section configured to transmit information related to relay searching to the other user terminal; and
a receiving section configured to receive information related to relay capability that is transmitted from the other user terminal,
wherein the transmitting section controls transmission of information related to relay searching based on reception conditions of the information related to relay capability.

9. The user terminal according to claim 8, comprising a control section configured to control a selection of a predetermined user terminal to be used for relaying, based on the number of times the information related to relay searching is received, or based on the connection state with the other user terminal that is identified by the information related to relay capability.

10. A radio communication method for a user terminal configured to connect with a radio base station and another user terminal, and configured to relay transmission between the radio base station and the other user terminal, said radio communication method comprising:
controlling a connection state with the radio base station;
transmitting information related to relay capability to the other user terminal; and
controlling a transmission the information related to relay capability based on the connection state with the radio base station.

11. The user terminal according to claim 2, wherein in the case where, in an existing system, transfer conditions for entering into an RRC idle state or transfer conditions for entering into a DRX mode are satisfied, and there are no other user terminals connected, the control section controls a transferring to the RRC idle state or the DRX mode.

12. The user terminal according to claim 2, wherein the control section controls a transferring to an RRC connected state or a normal mode based on reception conditions of the information related to relay searching.

13. The user terminal according to claim 3, wherein the control section controls a transferring to an RRC connected state or a normal mode based on reception conditions of the information related to relay searching.
